(19) United States
(12) Patent Application Publication
(10) Pub. No.: US 2018/0175965 A1
(43) Pub. Date: Jun. 21, 2018

(54) NETWORK CONTROL METHOD, NETWORK CONTROL DEVICE, AND STORAGE MEDIUM

(71) Applicant: FUJITSU LIMITED, Kawasaki-shi (JP)

(72) Inventor: Keiichi Nakatsugawa, Shinagawa (JP)

(73) Assignee: FUJITSU LIMITED, Kawasaki-shi (JP)

(21) Appl. No.: 15/823,812

(22) Filed: Nov. 28, 2017

(30) Foreign Application Priority Data
Dec. 15, 2016 (JP) 2016-243764

(51) Int. Cl. H04J 14/02; H04Q 11/00; H04B 10/077

(52) U.S. Cl. CPC H04J 14/0267; H04J 14/0257; H04L 45/70; H04B 10/0775; H04B 10/0773; H04Q 11/0062

(57) ABSTRACT

A network control method which is executed by a processor included in a network control device, the network control method includes measuring an amount of time of generation of an optical path that extends via a plurality of nodes in a network; and setting the optical path at a timing that is controlled based on the amount of measured time.

### CROSS-REFERENCE TO RELATED APPLICATION

This application is based upon and claims the benefit of priority of the prior Japanese Patent Application No. 2016-243764, filed on Dec. 15, 2016, the entire contents of which are incorporated herein by reference.

### FIELD

The embodiment discussed herein is related to a network control method, a network control device, and a storage medium.

### BACKGROUND

For example, in a large-scale backbone network of a communication carrier, or the like, between nodes coupled via optical fibers, traffic of a plurality of users is accommodated in a plurality of optical signals having different wavelengths and the optical signals are wavelength multiplexed and thus transmitted by wavelength division multiplexing (WDM) technology. For optical networks using WDM technology, for example, a technology of optical transport network (OTN) is defined in International Telecommunication Union Telecommunication Sector (ITU-T) Recommendation G.709/Y.1331.

Using the technology of OTN, an electric layer path which accommodates user traffic is set between user communication bases in an end-to-end manner, and an optical path (a wavelength path) on which a plurality of electric layer paths that have been multiplexed is mapped into a plurality of optical signals having different wavelengths is set between nodes of an optical network. Therefore, using the OTN technology, realization of a high-speed and flexible optical network is enabled by the two kinds paths, that is, the electric layer path and the optical path.

For example, in Request For Comments (RFC) 3717, a technology in which traffic of Ethernet (registered trademark, similar hereinafter) or traffic of Internet Protocol (IP) is accommodated in a label switched path (LSP) of Multi-Protocol Label Switching (MPLS) and the LSP is further accommodated in an optical path of WDM is defined.

The number of usable wavelengths in each node in an optical network of WDM is limited by a hardware configuration, such as the capacity and number of wavelength switches that are provided in the node or the like. In order to efficiently use this finite wavelength resource, for example, the optical network is designed, based on a statistical traffic demand, and an optical path is fixedly set between nodes.

However, in recent years, application of a software defined network (SDN) for an optical network has been considered. Then, management control of a flexible and dynamic optical network by software is becoming realized. Using SDN technology, it is enabled to generate a use request, that is, a demand, from a user or various applications to an optical network. Therefore, for a traffic demand, for example, it is expected that the number of optical paths, a time slot, or the like more dynamically changes than at a current time.

For such a traffic demand, all of optical paths that may be generated in the optical network may be prepared in advance. However, there is a problem in which, the larger a gap between a predicted traffic demand and an actual traffic demand is, the more frequently an excess or shortage occurs in the optical path. For example, if an excessively large number of optical paths have been set, in each of nodes that correspond thereto, a waste of power consumption of a transmitter that transmits an optical signal occurs, so that an operation cost of the optical path might be increased.

To solve above-described problem, for example, if an optical path is dynamically set or deleted in accordance with a demand occurrence state, the use efficiency of optical path is increased. Japanese Laid-open Patent Publication No. 08-139698, Japanese Laid-open Patent Publication No. 2002-198981, Japanese Laid-open Patent Publication No. 2012-502584, or the like discusses related art for setting of an optical path.

In setting of an optical path, setting processing which is performed for transmitting an optical signal having a wavelength which corresponds to the optical path is performed on a hardware component of each node via which the optical path extends. For example, in each node of the optical path, control processing, such as setting of a wavelength, temperature adjustment, or the like, is performed on a transmitter that transmits an optical signal.

Therefore, in a time period from a time at which a demand occurs to a time at which an optical path is provided to a user, a delay time (for example, several ten seconds to several minutes) occurs and, for example, there might be a case in which, if many demands occur in a short time, it is not able to provide an optical path before use of an optical path is started by the user, and therefore, a call loss occurs. In view of the foregoing, it is preferable to provide an optical path in a timely manner in accordance with a demand.

### SUMMARY

According to an aspect of the invention, a network control method which is executed by a processor included in a network control device, the network control method includes measuring an amount of time of generation of an optical path that extends via a plurality of nodes in a network; and setting the optical path at a timing that is controlled based on the amount of measured time.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating an example of a network system;

FIG. 2 is a configuration diagram illustrating an example of an optical transmission device;

FIG. 3 is a configuration diagram illustrating an example of a network monitoring control device;

FIG. 4 is a chart illustrating examples of a node database, a demand prediction information database, a demand occurrence information database, and a line management database;

FIG. 5 is a chart illustrating examples of an optical path management database, an optical path generation time database, and a threshold database;

FIG. 6 is a diagram illustrating an example of an optical path generation time measurement operation;

FIG. 7 is a flowchart illustrating an example of optical path generation time measurement processing;

FIG. 8 is a flowchart illustrating an example of demand accommodation processing;

FIG. 9 is a chart illustrating a first example of an optical path management operation;

FIG. 10 is charts illustrating the first example of an optical path management operation;

FIG. 11 is a chart illustrating a second example of the optical path management operation;

FIG. 12 is a chart illustrating a third example of the optical path management operation;

FIG. 13 is a chart illustrating a fourth example of the optical path management operation;

FIG. 14 is a chart illustrating a fifth example of the optical path management operation;

FIG. 15 is charts illustrating the fifth example of the optical path management operation;

FIG. 16 is a chart illustrating a sixth example of the optical path management operation;

FIG. 17 is charts illustrating the sixth example of the optical path management operation;

FIG. 18 is a chart illustrating a seventh example of the optical path management operation;

FIG. 19 is charts illustrating the seventh example of the optical path management operation;

FIG. 20 is a chart illustrating an eighth example of the optical path management operation;

FIG. 21 is a chart illustrating a ninth example of the optical path management operation;

FIG. 22 is chart illustrating a tenth example of the optical path management operation;

FIG. 23 is charts illustrating the tenth example of the optical path management operation;

FIG. 24 is a flowchart illustrating an example of pool path management processing;

FIG. 25 is a first flowchart illustrating an example of default path management processing;

FIG. 26 is a second flowchart illustrating the example of default path management processing;

FIG. 27 is a chart illustrating an example of a measurement target route for which an optical path generation time is measured;

FIG. 28 is a chart illustrating another example of the measurement target route for which an optical path generation time is measured;

FIG. 29 is a table illustrating another example of the threshold database; and

FIG. 30 is a flowchart illustrating another example of the demand accommodation processing.

### DESCRIPTION OF EMBODIMENTS

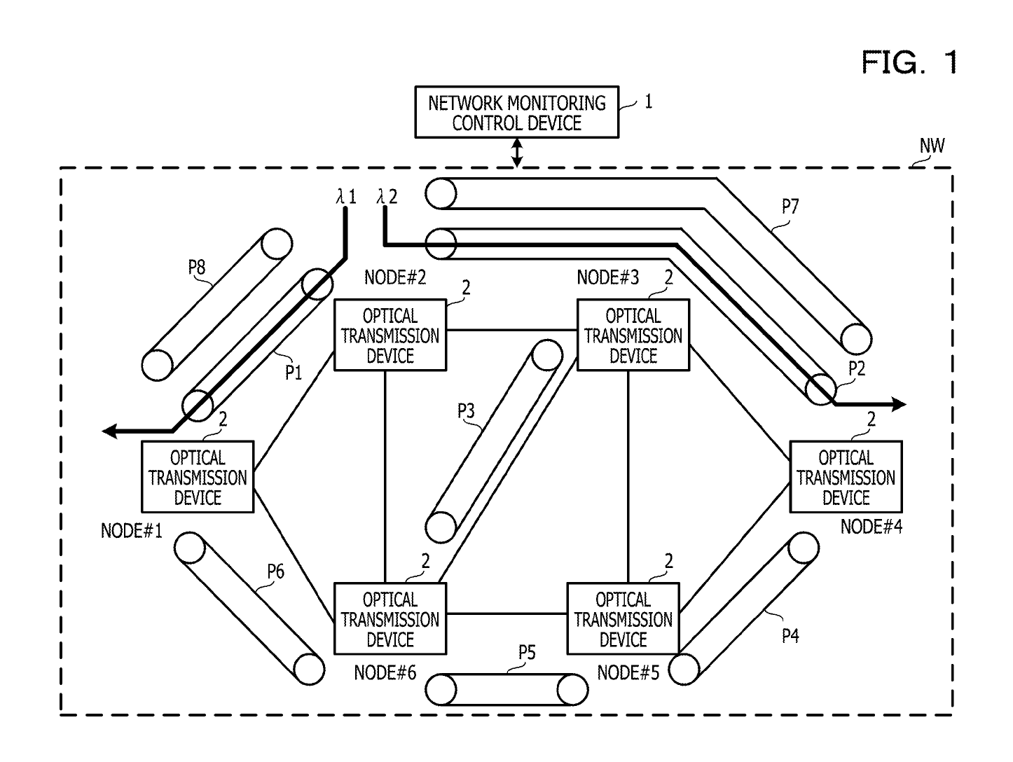

FIG. 1 is a configuration diagram illustrating an example of a network system. A network system includes a network NW including a plurality of nodes #1 to #6 and a network monitoring control device 1 that executes network monitoring control.

An optical transmission device is provided in each of the nodes #1 to #6. An optical transmission device 2 performs, as an example, optical transmission processing based on OTN defined in ITU-T Recommendation G.709/Y1331. The respective optical transmission devices 2 of the nodes #1 to #6 are coupled to one another via an optical fiber that is a transmission path.

For example, the optical transmission device 2 of the node #1 is coupled to the respective transmission devices 2 of the nodes #2 and #6, and the optical transmission device 2 of the node #3 is coupled to the respective optical transmission devices 2 of the node #2, #4, #5, and #6. The above-described connection form of the optical transmission devices 2 of the nodes #1 to #6 is merely an example and a connection form of the optical transmission devices 2 is not limited thereto. The number of nodes of the network NW in this example is six, but the number of nodes of the network NW is not limited thereto.

The network monitoring control device 1 is an example of a network control device and the network monitoring control device 1 performs a communication with the optical transmission device 2 of each of the nodes #1 to #6 via a network (not illustrated) used for performing monitoring control, thereby controlling the optical transmission device 2. More specifically, the network monitoring control device 1 sets optical paths (wavelength paths) P1 to P8 between the optical transmission devices 2. The optical paths P1 to P8 are routes used for transmitting a signal accommodated in a line path having a certain wavelength.

For example, the optical paths P1 and P8 are set between the node #1 and the node #2. Then, the optical paths P2 and P7 are set between the node #2, the node #3, and the node #4. A transmission capacity of each optical path is, as an example, 10 Gbps, but is not limited thereto.

The network monitoring control device 1 provides the optical paths P1 to P8 in accordance with a demand. More specifically, the network monitoring control device 1 selects an optical path which corresponds to a start node, an end node, a band, and a delay time which are specified in the demand. Then, the network monitoring control device 1 sets the optical transmission device 2 such that a line path in which a client signal is accommodated passes through the optical path. The optical paths P1 to P8 are able to accommodate line paths in a range in which the total of bands of the line paths is an upper limit (10 Gbps) or less.

For example, one line path passes through the optical path P1 having a wavelength λ1 and another line path passes through the optical path P2 having a wavelength λ2. Each of the line paths corresponds to a path of a low-order optical channel data unit (LO-ODU) in OTN. In MPLS, each of the line paths corresponds to LSP. As for a transmission direction, the optical paths P1 to P8 are bidirectionally provided. However, in an example below, only the optical paths P1 to P8 in one transmission direction will be described.

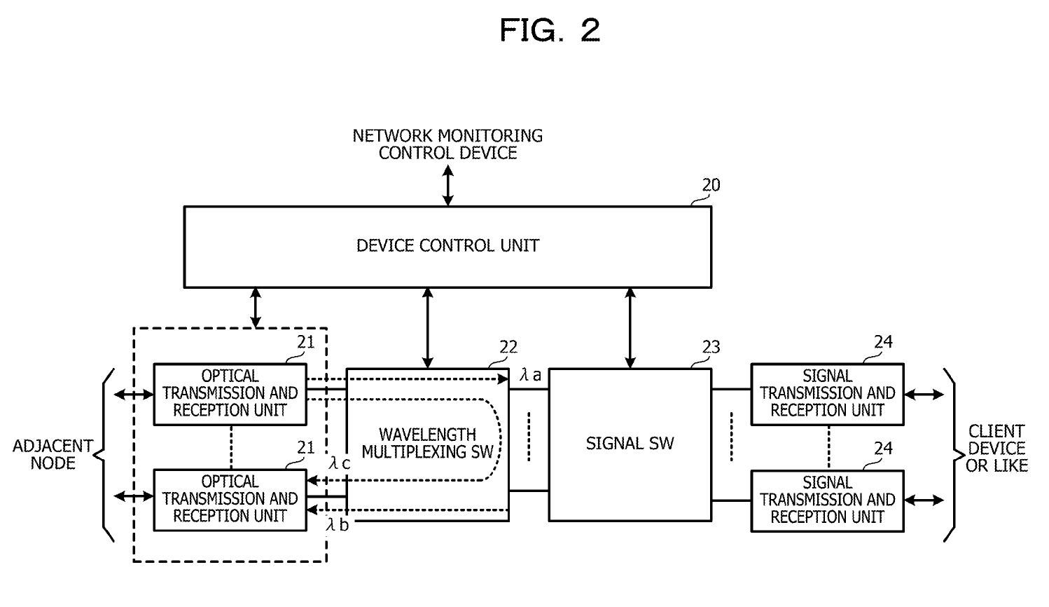

FIG. 2 is a configuration diagram illustrating an example of the optical transmission device 2. The optical transmission device 2 includes a device control unit 20, a plurality of optical transmission and reception units 21, a wavelength multiplexing switch (SW) unit 22, a signal switch (SW) unit 23, and a plurality of signal transmission and reception units 24.

The device control unit 20 is formed of, for example, a central processing unit (CPU) circuit or the like and controls the plurality of optical transmission and reception units 21, the wavelength multiplexing switch unit 22, and the signal switch unit 23. The device control unit 20 communicates with the network monitoring control device 1 and performs an optical path generation control on the plurality of optical transmission and reception units 21, the wavelength multiplexing switch unit 22, and the signal switch unit 23. For a communication of the device control unit 20 and the network monitoring control device 1, for example, Transaction Languate-1 (TL1), OpenFlow (registered trademark), NETCONF, or the like is used.

The optical transmission and reception units 21 transmit or receive a wavelength multiplexed optical signal including wavelength lights having different wavelengths between the optical transmission device 2 of a self-node of the nodes #1 to #6 and the optical transmission device 2 of the other ones of the nodes #1 to #6. More specifically, the optical transmission and reception units 21 amplify a wavelength multiplexed optical signal that has been input from the wavelength multiplexing switch unit 22 and thus transmit the amplified signal. Then, the optical transmission and reception units 21 amplify the wavelength multiplexed optical signal that has been received and output the amplified signal to the wavelength multiplexing switch unit 22. The optical transmission and reception units 21 are formed of, for example, laser diodes or erbium-doped fibers, which are used for amplifying a wavelength multiplexed optical signal.

The wavelength multiplexing switch unit 22 converts an electrical signal of an OUT frame which has been input from the signal switch unit 23 to a plurality of wavelength lights on which the OUT frame is mapped. Then, the wavelength multiplexing switch unit 22 wavelength-multiplexes line paths thereof to obtain a wavelength multiplexed optical signal and outputs the wavelength multiplexed optical signal to one of the optical transmission and reception units 21, which corresponds to a destination thereof. The wavelength multiplexing switch unit 22 separates the wavelength multiplexed optical signal that has been input from the optical transmission and reception units 21 into wavelength lights in accordance with wavelengths. Then, the wavelength multiplexing switch unit 22 converts the wavelength lights to an electrical signal that is demapped in an OUT frame and outputs the electrical signal to the signal switch unit 23.

The wavelength multiplexing switch unit 22 is formed of, for example, a wavelength selection switch or the like. The wavelength multiplexing switch unit 22 sets a wavelength of a wavelength light that is to be wavelength multiplexed to a wavelength multiplexed optical signal and a wavelength of a wavelength light that is to be separated from a wavelength multiplexed optical signal for each input and output port in accordance with an instruction from the device control unit 20.

The signal switch unit 23 maps electrical client signals that have been input from the plurality of signal transmission and reception units 24 into an OUT frame. Mapping processing is executed in accordance with an instruction of the device control unit 20. Thus, the client signals are accommodated in the LO-ODU, the LO-ODU is accommodated in a superordinate high-order optical channel data unit (HO-ODU), and the HO-ODU is mapped in the OTU frame. The signal switch unit 23 outputs the OTU frame in which the electrical client signals have been mapped to the wavelength multiplexing switch unit 22.

The signal switch unit 23 outputs a demapped client signal to the signal transmission and reception units 24. Then, the signal switch unit 23 maps the client signal in an OUT frame and outputs the OUT frame to the wavelength multiplexing switch unit 22.

The wavelength multiplexing switch unit 22 transmits or receives a wavelength light having a wavelength that has been instructed by the device control unit 20. Thus, the optical transmission and reception unit 21 performs, for example, setting for a wavelength of a laser diode, temperature adjustment, filtering setting for a wavelength of a wavelength light that is to be received, or the like when generating an optical path.

The signal transmission and reception unit 24 is coupled to a client device including a terminal, a router, or the like, and transmits or receives a client signal to or from the client device. The signal transmission and reception unit 24, for example, converts a format of a client signal that has been received from the client device and outputs the signal the format of which has been converted to the signal switch unit 23. The signal transmission and reception units 24, for example, converts a format of a client signal that has been input from the signal switch unit 23 and transmits the client signal the format of which has been converted to the signal transmission and reception units 24. The signal transmission and reception units 24 is formed of hardware, such as, for example, a transmitter, a receiver, or the like.

A dotted line indicates a route of a wavelength light. In an end node of an optical path of a wavelength λa, a wavelength light of the wavelength λa is received in a state in which the wavelength light is included in the wavelength multiplexed optical signal by the optical transmission and reception units 21, is separated from the wavelength multiplexed optical signal by the wavelength multiplexing switch unit 22, is converted to an electrical signal, and is input to the signal switch unit 23. Thus, the wavelength light of the wavelength λa is received as a client signal by the signal transmission and reception unit 24.

In a start node of an optical path of a wavelength λb, a wavelength light having the wavelength λb is generated from a client signal that has been input to the wavelength multiplexing switch unit 22 from the signal switch unit 23 and is wavelength multiplexed with a wavelength light of another wavelength λc in the wavelength multiplexing switch unit 22. Thus, the wavelength light of the wavelength λb is transmitted as a wavelength multiplexed optical signal to a transmission path from the optical transmission and reception units 21.

In a relay node of an optical path of the wavelength λc, a wavelength light having the wavelength λc is received in a state in which the wavelength light is included in a wavelength multiplexed optical signal by the optical transmission and reception units 21 and is separated from the wavelength multiplexed optical signal by the wavelength multiplexing switch unit 22. The wavelength light of the wavelength λc is folded inside the wavelength multiplexing switch unit 22 toward a relay destination and, again, is multiplexed with a wavelength light having another wavelength and output to the optical transmission and reception units 21. Thus, the wavelength light having the wavelength λc is transmitted from the optical transmission and reception units 21 to some other one of the nodes #1 to #6 than one of the nodes #1 to #6 which is a reception source.

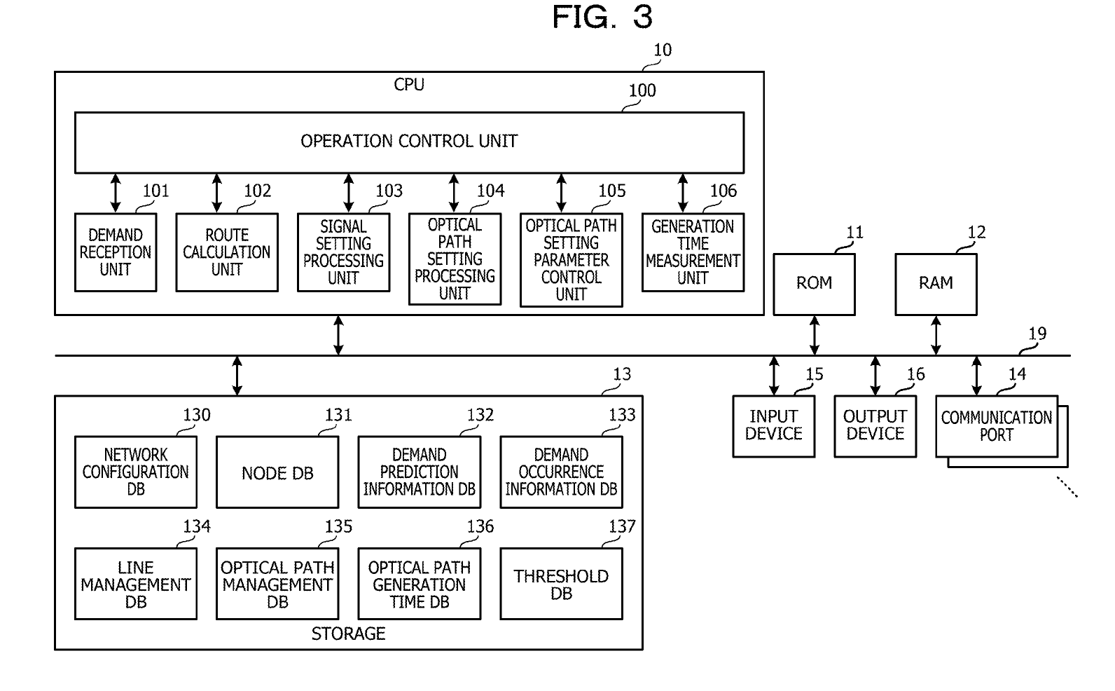

FIG. 3 is a configuration diagram illustrating an example of the network monitoring control device 1. As the network monitoring control device 1, for example, a network management system (NMS), an element management system (EMS), a SDN controller, or the like is used.

The network monitoring control device 1 includes a CPU 10, a read only memory (ROM) 11, a random access memory (RAM) 12, a storage 13, a plurality of communication ports 14, an input device 15, and an output device 16. The CPU 10 is coupled to the ROM 11, the RAM 12, the storage 13, the plurality of communication ports 14, the input device 15, and the output device 16 via a bus 19 so that the above-described components are able to input or output a signal to or from one another. The CPU 10 is an example of a computer.

Programs that drive the CPU 10 are stored in the ROM 11 or the storage 13. The programs include an operating system (OS) and a network control program that executes a network control method. The RAM 12 functions as a working memory of the CPU 10. The plurality of communication ports 14 is, for example, wireless local area network (LAN) cards or network interface cards (NIC) and communicates with the optical transmission device 2 of each of the nodes #1 to #6 or another communication terminal.

The input device 15 is a device that inputs information to a control server 1. The input device 15 is, for example, a keyboard, a mouse, a touch panel, or the like. The input device 15 outputs information that has been input to the CPU 10 via the bus 19.

The output device 16 is a device that outputs information of the control server 1. The output device 16 is, for example, a display, a touch panel, a printer, or the like. The output device 16 acquires information from the CPU 10 via the bus 19 and outputs the information.

When the CPU 10 reads a program from the ROM 11 or the storage 13, as functions, an operation control unit 100, a demand reception unit 101, a route calculation unit 102, a signal setting processing unit 103, an optical path setting processing unit 104, an optical path setting parameter control unit 105, and a generation time measurement unit 106 are formed. A network configuration database (which will be hereinafter referred to as DB) 130, a node DB 131, a demand prediction information DB 132, a demand occurrence information DB 133, a line management DB 134, an optical path management DB 135, an optical path generation time DB 136, and a threshold DB 137 are stored in the storage 13. The storage 13 is, for example, a hard disk drive or a solid state drive.

The network configuration DB 130, the node DB 131, the demand prediction information DB 132, the demand occurrence information DB 133, the line management DB 134, the optical path management DB 135, the optical path generation time DB 136, and the threshold DB 137 may be duplicated from the storage 13 in the RAM 12. In this case, the CPU 10 may be configured to read each of the DBs 130 to 137 from the RAM 12. As another option, the network configuration DB 130, the node DB 131, the demand prediction information DB 132, the demand occurrence information DB 133, the line management DB 134, the optical path management DB 135, the optical path generation time DB 136, and the threshold DB 137 may be input from the input device 15 or the communication ports 14 and may be stored in the storage 13 or the RAM 12.

The operation control unit 100 controls an entire operation of the network monitoring control device 1. The operation control unit 100 instructs the demand reception unit 101, the route calculation unit 102, the signal setting processing unit 103, the optical path setting processing unit 104, the optical path setting parameter control unit 105, and the generation time measurement unit 106 to perform corresponding operations.

The demand reception unit 101 receives a demand that has been input, for example, from the input device 15 or the communication ports 14. The demand is an example of a request for use of the network NW, for example, from a network administrator or an application to which SDN is applied. The demand includes demand information, such as an identifier of a client signal that is to be accommodated in a line path, a start node that is to be a transmission source of the client signal, an end node that is to be a transmission destination of the client signal, a band, a delay time, or the like. The demand reception unit 101 registers the demand information in the demand occurrence information DB 133 and notifies the operation control unit 100 of occurrence of a demand.

When the operation control unit 100 receives a notification of the occurrence of a demand, the operation control unit 100 instructs the route calculation unit 102 to calculate a route that corresponds to the demand. The route calculation unit 102 acquires the demand information from the demand occurrence information DB 133 and calculates a route that connects the start node and the end node, which has been requested, for example, by a minimum distance method. In this case, the route calculation unit 102 refers to the network configuration DB 130. Information that indicates a relationship of the nodes #1 to #6 in the network NW and links between the nodes #1 to #6.

The route calculation unit 102 notifies the operation control unit 100 of the route as a calculation result. If a route that corresponds to the demand has not been calculated due to a wavelength shortage or a band shortage, the route calculation unit 102 notifies the operation control unit 100 that there is not a corresponding route.

When the operation control unit 100 receives a notification of a route, the operation control unit 100 instructs the signal setting processing unit 103 to perform setting of conduction of a client signal in accordance with the demand in the route. The signal setting processing unit 103 selects an optical path that matches the route that has been instructed from the optical path management DB 135 and performs setting of accommodation of the client signal on each of the optical transmission devices 2 of a start node, a relay node, and an end node of the optical path. In each of the optical transmission devices 2, the device control unit 20 performs setting on each of the units 21 to 23 so that the client signal is accommodated as a line path in the optical path.

When setting of accommodation of the client setting is completed, the signal setting processing unit 103 registers the client signal in the line management DB 134. The signal setting processing unit 103 notifies the operation control unit 100 of completion of setting of accommodation.

The optical path setting processing unit 104 is an example of a setting processing unit. The optical path setting processing unit 104 sets the optical paths P1 to P8 that extend via the plurality of nodes #1 to #6 in the network NW. The optical path setting processing unit 104 instructs the optical transmission device 2 of each of the nodes #1 to #6 on the route of the optical paths P1 to P8 to generate the optical paths P1 to P8 to via the corresponding one of the communication ports 14. This instruction includes wavelengths of the optical paths P1 to P8, a path (input source and output destination nodes), or the like.

The number of usable wavelengths in the optical transmission devices 2 is limited by a hardware configuration, such as the capacity and number of the wavelength multiplexing switch units 22 provided in the corresponding optical transmission devices 2. Thus, the optical path setting processing unit 104 sets a static optical path (which will be hereinafter referred to as a “default path”) based on a predicated demand and sets a dynamic optical path (which will be hereinafter referred to as a “pool path”) based on an actual demand. Thus, the network monitoring control device 1 efficiently provides a finite wavelength resource in accordance with a demand.

Before the network NW is used, the optical path setting processing unit 104 sets a default path in the network NW, based on the demand prediction information DB 132. The demand prediction information DB 132 is demand information that has been predicted in advance, based on the number of users in an area to which each of the nodes #1 to #6 belongs, and is stored in the storage 13 in advance.

The optical path setting processing unit 104 increases or decreases the default path in every certain cycle Ta, based on a demand that has occurred in the cycle Ta. In this case, the optical path setting processing unit 104 acquires demand information in the cycle Ta from the demand occurrence information DB 133.

As described above, the optical path setting processing unit 104 controls the number of default paths in accordance with a demand occurrence state (occurrence trend) in the cycle Ta, and therefore, it is enabled to provide a default path in a timely manner in accordance with the demand. The cycle Ta will be referred to as a “default path management cycle Ta” below.

When a band of an optical path is assigned to a line path (which accommodates a client signal) in accordance with the demand, the optical path setting processing unit 104 compares the total of available bands of all of optical paths that overlap with the route to a threshold TH. When the total of the available bands is the threshold TH or less, the optical path setting processing unit 104 sets a new pool path. In this case, the optical path setting processing unit 104 acquires the threshold TH from the threshold DB 137.

As described above, the optical path setting processing unit 104 dynamically sets a pool path in accordance with a demand, and therefore, even when default paths are running short because more demands than predicted have occurred, the optical path setting processing unit 104 is able to prepare a pool path for further occurrence of a demand.

However, in the optical transmission device 2 of each of the nodes #1 to #6 via which an optical path of a setting target extends, as described above, for example, setting for a wavelength of a laser diode, temperature adjustment, and setting for filtering of a wavelength of a wavelength light that is to be received are performed when generating an optical path. Therefore, in a time period from a time at which a demand occurs to a time at which an optical path is provided, a delay time (for example, several ten seconds to several minutes) occurs and there might be a case in which, for example, if many demands occur in a short time, it is not able to provide an optical path before use of an optical path is started by the user, and thus, a call loss occurs.

Thus, the optical path setting parameter control unit 105 controls a timing at which an optical path is set in accordance with an amount of time (which will be hereinafter referred to as an “optical path generation time”) which it takes for the optical transmission device 2 of each of the nodes #1 to #6 via which the optical path of a setting target extends to generate an optical path. In this case, the optical path setting parameter control unit 105 acquires the optical path generation time from the optical path generation time DB 136.

Therefore, the network monitoring control device 1 is able to set a pool path at a proper timing (that is, at an early timing) determined in expectation of the optical path generation time. Therefore, the network monitoring control device 1 is able to provide an optical path in a timely manner in accordance with a demand without causing a call loss to be generated. The optical path setting parameter control unit 105 is an example of a control unit.

More specifically, the optical path setting parameter control unit 105 controls a timing at which an optical path is set by adjusting the threshold TH in the threshold DB 137 in accordance with the optical path generation time. Therefore, when the threshold TH increases, a timing at which the entire available band reduces in accordance with occurrence of a demand to be the threshold TH or less is advanced, and when the threshold TH reduces, a timing at which the entire available band reduces in accordance with occurrence of a demand to be the threshold TH or less is delayed.

Therefore, the optical path setting parameter control unit 105 is able to control a timing at which a pool path is additionally set, based on the generation time which it takes to generate an optical path and the total of available bands. The optical path setting parameter control unit 105 is not limited thereto and may be configured to control a timing at which a pool path is additionally set, for example, based on the generation time which it takes to generate an optical path and the number of unused pool paths (there may be an upper limit that may be set), as will be described later.

When an available band of an optical path changes, for example, due to generation or deletion of a line path, the optical path setting processing unit 104 compares a band (which will be hereinafter referred to as a “predicted band”) of a demand which has been predicted and a band (which will be hereinafter referred to as an “occurrence band”) of a demand which has actually occurred to one another and increases or reduces a pool path in accordance with a result of the comparison. In a period in which pool path management processing which has been described above is executed, the optical path setting parameter control unit 105 controls a timing at which a pool path is additionally set. The optical path setting processing unit 104 may be configured to execute pool path management processing in every certain period.

More specifically, if the ratio of the occurrence band to the predicted band is a certain value Ka or more, the optical path setting processing unit 104 increases the pool path in accordance with the optical path generation time and, if the ratio of the occurrence band to the predicted band is a certain value Kb or less, the optical path setting processing unit 104 reduces the pool path in accordance with the optical path generation time. In either case, the optical path setting parameter control unit 105 changes the threshold TH in accordance with the optical path generation time. If neither of the above cases apply, increase or reduction of the pool path and change of the threshold TH are not executed.

If, at the arrival of the default path management cycle Ta, the optical path setting processing unit 104 determines that there is not continuity in the demand occurrence state during the default path management cycle Ta, increase or reduction of the pool path and change of the threshold TH, which have been described above, are executed.

The generation time measurement unit 106 is an example of a measurement unit. The generation time measurement unit 106 executes a measurement of the optical path generation time on the optical transmission devices 2 of the plurality of nodes #1 to #6 on an optical path of a setting target. The operation control unit 100 instructs the generation time measurement unit 106 to measure the optical path generation time, for example, before use of the network NW is started or, even after use of the network NW is started, in a time slot (for example, early in morning or late at night) in which the frequency of use is low. The generation time measurement unit 106 requests the optical path setting processing unit 104 to generate an optical path of a temporarily unused wavelength via the operation control unit 100 when performing a measurement.

The generation time measurement unit 106 registers the optical path generation time that has been measured in the optical path generation time DB 136 in the storage 13. The storage 13 is an example of a storage unit and stores the optical path generation time. Thus, the optical path setting parameter control unit 105 is able to acquire the optical path generation time that has been measured from the optical path generation time DB 136, and therefore, labor and time involved in measuring the optical path generation time is reduced each time a control of the threshold TH is performed.

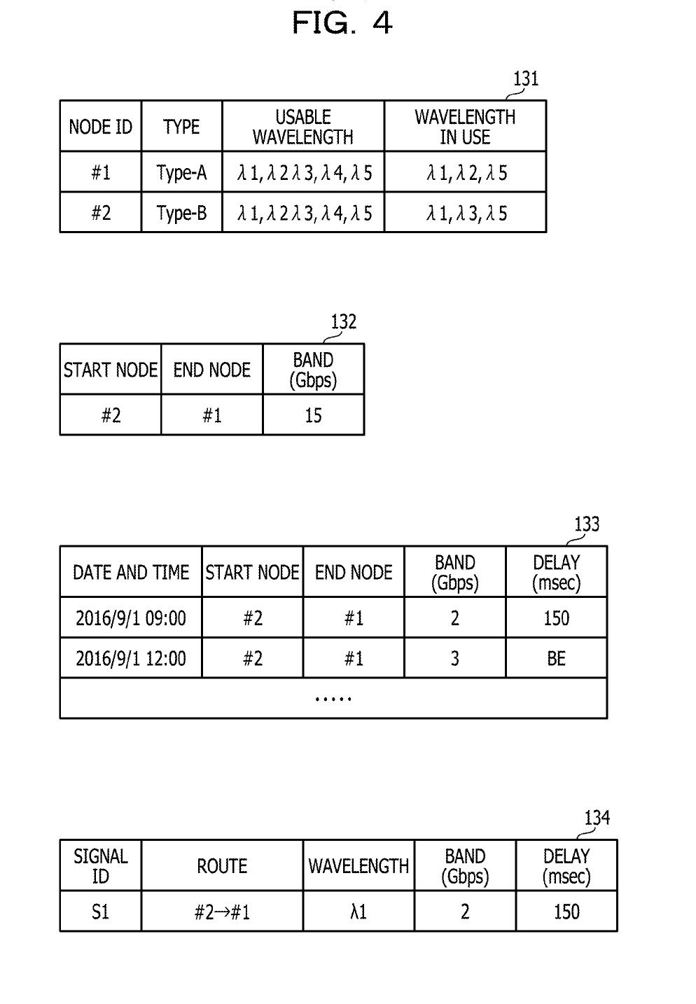

FIG. 4 is a chart illustrating examples of the node DB 131, the demand prediction information DB 132, the demand occurrence information DB 133, and the line management DB 134. In the node DB 131, “NODE ID”, “TYPE”, “USABLE WAVELENGTH”, and “WAVELENGTH IN USE” are registered. “NODE ID” is an identifier of each of the nodes #1 to #6. “TYPE” is a type (“Type-A”, “Type-B”, or the like) of each of the nodes #1 to #6 and is determined, for example, by a model number (for example, a manufacturer number) of the optical transmission device 2 of the corresponding one of the nodes #1 to #6. “USABLE WAVELENGTH” indicates wavelengths λ1 to λ5 that are usable for generation of an optical path in the corresponding one of the nodes #1 to #6. “WAVELENGTH IN USE” is one or ones of the wavelengths λ1 to λ5 which have been already used for generating an optical path in the corresponding one of the nodes #1 to #6, that is, one or more of the wavelengths which are not usable for generating a new optical path. For example, in the node #1, the wavelengths λ1, λ2, and λ5 of the usable wavelengths λ1 to λ5 are not usable.

The node DB 131 is used for performing route calculation processing by the route calculation unit 102, measurement processing by the generation time measurement unit 106, or the like.

In the demand prediction information DB 132, a start node, an end node, and a band (Gbps) are registered. The band corresponds to the predicted band and is a prediction value for a band that is requested for a route that connects the start node and the end node in a demand. The demand prediction information DB 132 is stored in the storage 13 in advance before use of the network NW is started.

In the demand occurrence information DB 133, a date and time at which a demand has occurred, a start node, an end node, a band (Gbps), and a delay (msec) are registered. The start node, the end node, the band (Gbps), the delay (msec) are acquired from demand information. The demand occurrence information DB 133 is updated by the demand reception unit 101.

The demand prediction information DB 132 and the demand occurrence information DB 133 are used for optical path setting processing of the optical path setting processing unit 104 or the like.

In the line management DB 134, a signal ID, a route, a wavelength, a band (Gbps), and a delay are registered. The signal ID is an identifier of a line path that is accommodated in an optical path by a demand. In the line management DB 134 of this example, it is registered that a line path of a signal ID “S1” is accommodated in an optical path of the wavelength λ1, which passes through a route between a start node #2 to an end node #1, a band thereof is 2 Gbps, and a delay thereof is 150 msec. The line management DB 134 is updated by the signal setting processing unit 103.

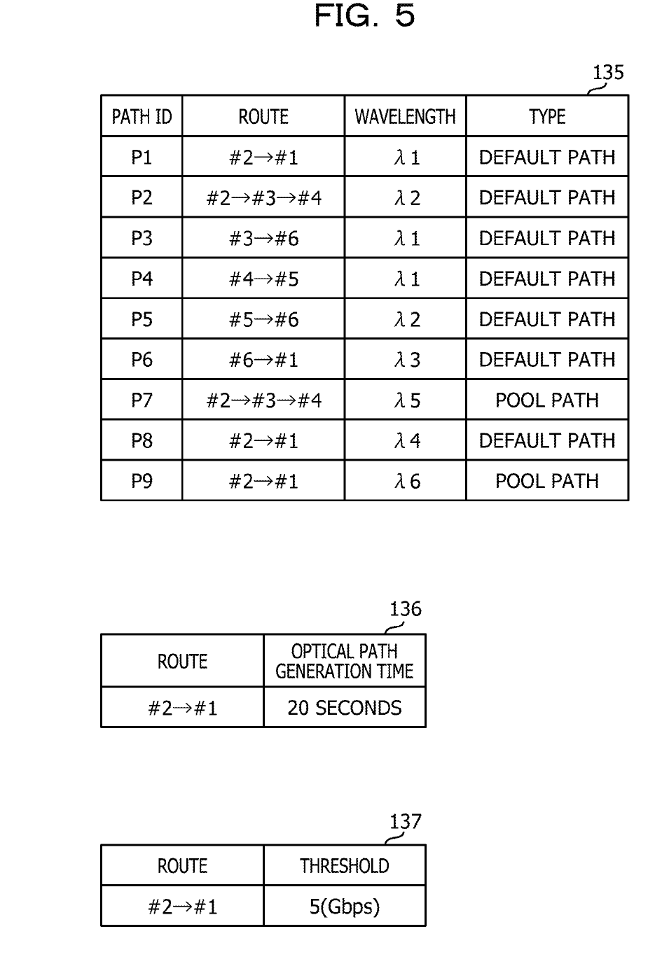

FIG. 5 is a chart illustrating examples of the optical path management DB 135, the optical path generation time DB 136, and the threshold DB 137. In the optical path management DB 135, a path ID that is an identifier of each of the optical paths P1 to P8 and a route, a wavelength, and a type (default path or pool path) of the corresponding one of the optical paths P1 to P8 are registered. The optical path P9 will be described in an example described later.

In the optical path management DB 135 of this example, the optical paths P1 to P8 illustrated in FIG. 1 are registered. For example, the optical path P1 is a default path of the wavelength λ1 which extends from the start node #2 to the end node #1. The optical path P2 is a default path of the wavelength λ2 which extends from the start node #2 to the end node #4 via a relay node #3. Although not illustrated in FIG. 1, the optical path P9 is a pool path of the wavelength λ6 which extends from the start node #2 to the end node #1. The optical path management DB 135 is updated by the optical path setting processing unit 104. The optical path management DB 135 is used for signal setting processing of the signal setting processing unit 103.

In the optical path generation time DB 136, the optical path generation time of an optical path of a setting target, that is, an optical path that has not been set, is registered. In this example, 20 seconds is registered as the optical path generation time of the route from the start node #2 to the end node #1. That is, the optical path generation time of each of the optical paths P1 and P8 in FIG. 1 is 20 seconds. The optical path generation time DB 136 is updated by the generation time measurement unit 106. The optical path generation time DB 136 is used for optical path setting processing of the optical path setting processing unit 104.

In the threshold DB 137, the threshold TH of the total of available bands for each route in the network NW is registered. In this example, 5 Gbps is registered as the threshold TH of the total of available bands of all of the optical paths from the start node #2 to the end node #1. In this case, when the total of available bands of all of the optical paths from the start node #2 to the end node #1 is 5 Gbps or less, the optical path setting processing unit 104 adds a pool path. The threshold DB 137 is updated by the optical path setting parameter control unit 105.

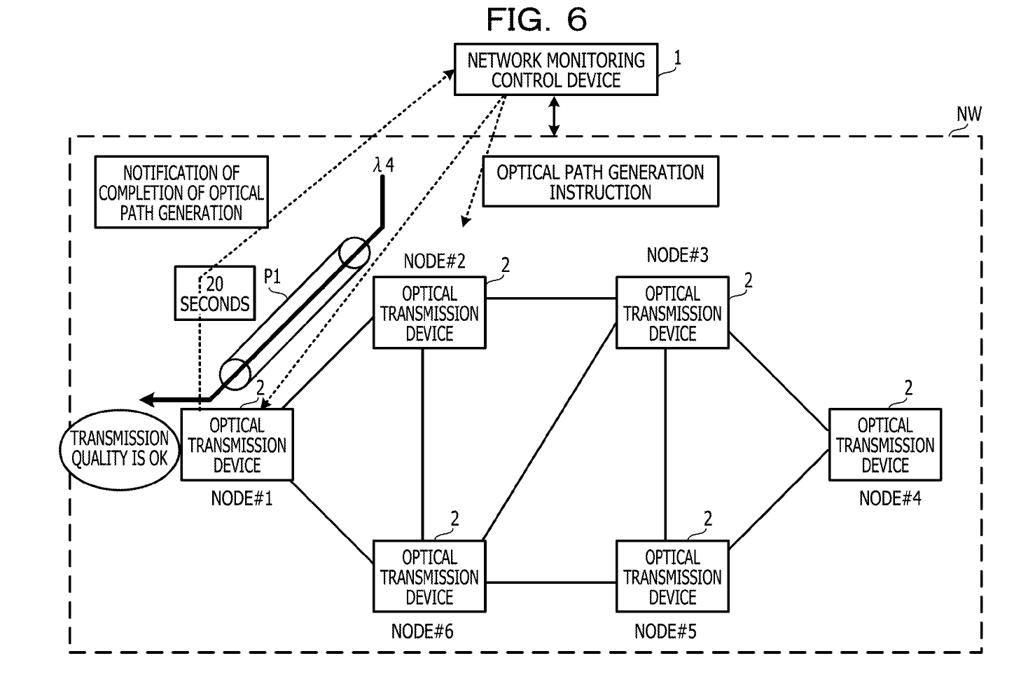

FIG. 6 is a diagram illustrating an example of a measurement operation of measuring a generation time which it takes to generate the optical path P1. In the network monitoring control device 1, the generation time measurement unit 106 determines a wavelength that is used for performing a measurement, based on the node DB 131. In the node DB 131 of FIG. 4, a usable wavelength which is common with the start node #2 and the end node #1 of the optical path P1 is λ4. Therefore, the generation time measurement unit 106 determines use of the wavelength λ4 and requests the optical path setting processing unit 104 to set an optical path of the wavelength λ4.

The optical path setting processing unit 104 instructs each of the optical transmission devices 2 of the start node #2 and the end node #1 to generate an optical path (see “optical path generation instruction”). In this case, the generation time measurement unit 106 starts a timer that measures the optical path generation time. When generation of an optical path is completed, the optical transmission device 2 of the node #1 notifies the network monitoring control device 1 of the completion (see a notification of completion of optical path generation). When the network monitoring control device 1 receives the notification, the network monitoring control device 1 stops the timer and acquires a timer value as the optical path generation time (20 seconds in this example).

The generation time measurement unit 106 may be configured to measure a time from a time at which the plurality of the nodes #1 to #6 via which the optical path extends is instructed to generate an optical path to a time at which transmission quality of the optical path satisfies a certain condition. Thus, the optical path P1 of the wavelength λ4 is set from the start node #2 to the end node #1.

The optical transmission device 2 monitors the transmission quality of the optical path P1 of the wavelength λ4. More specifically, for example, the signal switch unit 23 of the optical transmission device 2 measures a bit error rate (or a noise ratio) by forward error correction (FEC) in an OUT frame that has been mapped in the optical path P1 and notifies, using a result indicating that the bit error rate has gone below a certain value (see “transmission quality OK”) as a condition, that generation of an optical path is completed. The signal switch unit 23 may be configured to notify, using a stop of an alarm of a signal loss, a frame loss or the like for an optical path as a condition, that generation of the optical path is completed.

As described above, in a case in which the generation time measurement unit 106 has measured, as the optical path generation time, a time from a time at which an optical path generation instruction is given to a time at which transmission quality of an optical path satisfies a certain condition, the optical path generation time includes not only a time which it takes to generate an optical path but also a time which it takes for transmission quality in the optical path to be stabilized. Therefore, the optical path setting processing unit 104 is able to provide an optical path in a more timely manner in accordance with a demand.

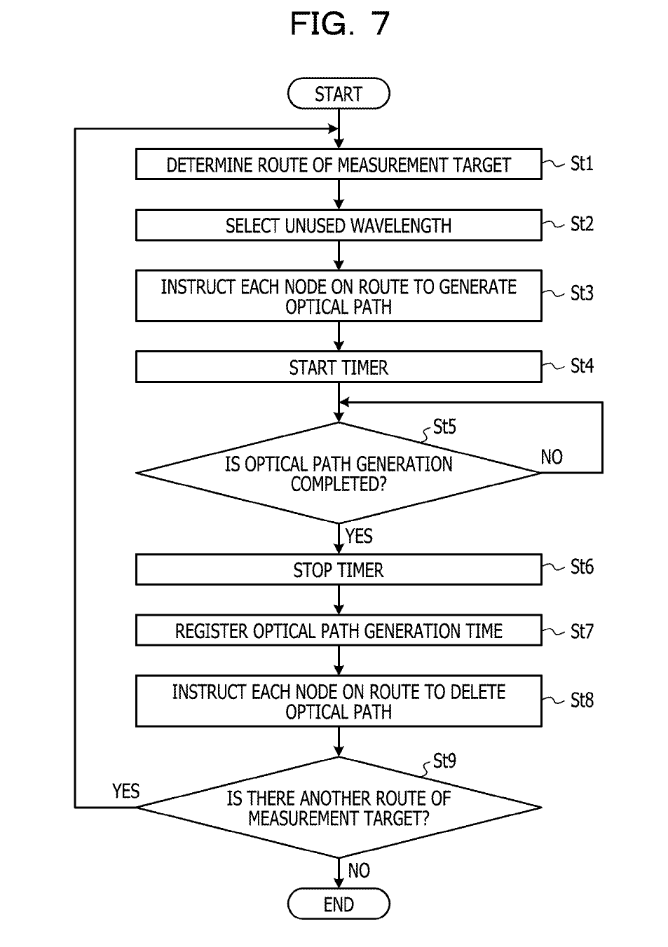

FIG. 7 is a flowchart illustrating an example of measurement processing of measuring a generation time which it takes to generate an optical path. This processing is executed, for example, before use of the network NW is started or, even after use of the network NW is started, in a time slot (for example, early in morning or late at night) in which the frequency of use is low.

The operation control unit 100 determines a route of a measurement target for which the optical path generation time is measured (St1). Next, the generation time measurement unit 106 selects, based on the node DB 131, a usable wavelength which is common with each of the nodes #1 to #6 on the route, that is, an unused wavelength (St2).

Next, the generation time measurement unit 106 instructs each of the nodes #1 to #6 on the route to generate an optical path of the selected wavelength (St3). Next, the generation time measurement unit 106 starts the timer (St4). Next, the generation time measurement unit 106 determines whether or not a notification of completion of generation of an optical path has been received from a terminal node (St5). If the notification has not been received (NO in St5), processing of St5 is executed again.

If the notification of completion of generation of an optical path has been received (YES in St5), the generation time measurement unit 106 stops the timer (St6). Next, the generation time measurement unit 106 registers the timer value as the optical path generation time in the optical path generation time DB 136 (St7). Next, the generation time measurement unit 106 instructs each of the nodes #1 to #6 on the route to delete the optical path that has been used for performing a measurement (St8).

Next, the operation control unit 100 determines whether or not there is another route of a measurement target (St9). If there is another route (YES in St9), the operation control unit 100 determines another route in St1 and executes processing of St2 and subsequent processing. If there is not another path (NO in St9), the process ends. In a manner described above, the measurement processing of measuring a generation time which it takes to generate an optical path is executed.

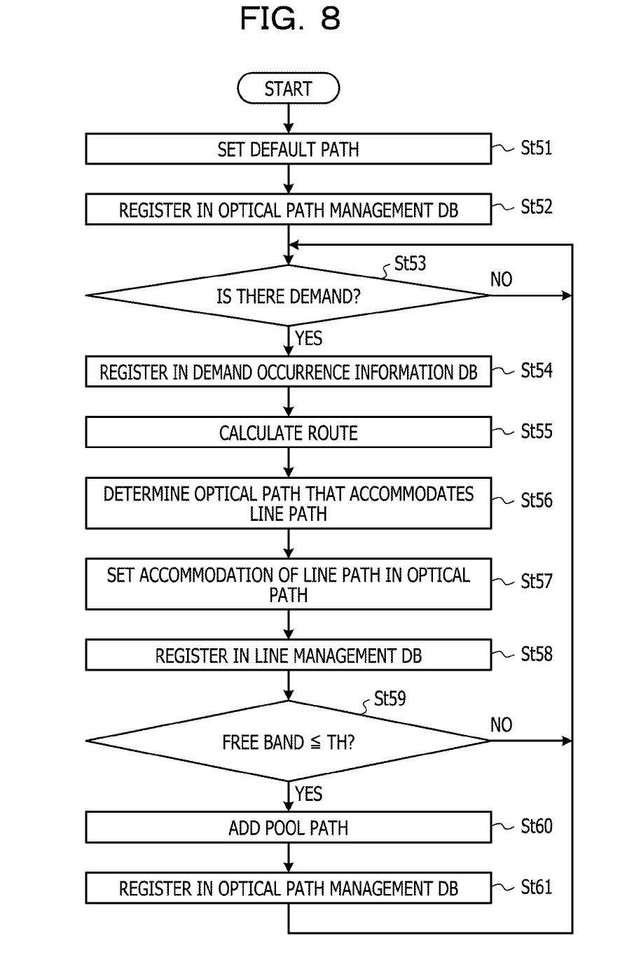

FIG. 8 is a flowchart illustrating an example of demand accommodation processing. The optical path setting processing unit 104 sets a default path, based on the demand prediction information DB 132 (St51). Next, the optical path setting processing unit 104 registers the default path in the optical path management DB 135 (St52).

Next, the demand reception unit 101 determines whether or not there is a demand (St53). If there is not a demand (NO in St53), processing of St 53 is executed again. If a demand has occurred (YES in St53), the demand reception unit 101 registers demand information thereof in the demand occurrence information DB 133 (St54).

Next, the route calculation unit 102 calculates a route from a start node to an end note of the demand occurrence information DB 133 (St55). Next, the route calculation unit 102 determines, based on a result of the route calculation, an optical path (a default path or a pool path) that accommodates a line path (a client signal) which is requested by the demand from the optical path management DB 135 (St56). In this case, the route calculation unit 102 selects an optical path that satisfies a band and a delay which are specified by the demand.

Next, the signal setting processing unit 103 performs setting of accommodation of a line path on the optical transmission device 2 of each of the nodes #1 to #6 on the optical path (St57). In each of the optical transmission devices 2, the device control unit 20 performs setting on the optical transmission and reception units 21, the wavelength multiplexing switch unit 22, and the signal switch unit 23 so that the client signal that is specified by the demand is multiplexed on a line path of a wavelength that corresponds to an optical path of an accommodation destination. Thus, a band of the optical path that has been set is assigned to a line path that accommodates a client signal. Next, the signal setting processing unit 103 registers information of the line path in the line management DB 134 (St58).

Next, the optical path setting processing unit 104 compares the total of available bands of all of the optical paths which extend via the nodes #1 to #6 which are common with the optical path of the accommodation destination of the line path to the threshold TH (St59). In this case, the optical path setting processing unit 104 calculates the total of available bands from contents of the optical path management DB 135 and the line management DB 134. If the total of available bands is larger than the threshold TH (NO in St59), the processing of St53 and subsequent processing are executed again.

If the total of available bands is the threshold TH or less (YES in St59), the optical path setting processing unit 104 additionally sets a pool path on the same route as the optical path of the above-described line path (St60). Next, the optical path setting processing unit 104 registers the pool path that has been added in the optical path management DB 135 (St61). Thereafter, the processing of St53 and subsequent processing are executed again.

As described above, the optical path setting processing unit 104 assigns a band of an optical path that has been set in the network NW to a line path in accordance with a demand and sets, when the total of available bands of all of the optical paths routes of which are common with the line path is the threshold TH or less, an optical path for the route. Therefore, the optical path setting processing unit 104 is able to prepare a pool path for a demand in accordance with a use state of the band of the optical path.

Next, optical path management will be described. Optical path management is performed separately for default path and pool path. The default path is increased or reduced in every default path management cycle Ta in accordance with the optical path generation time, the pool path is increased or reduced in every default path management cycle Ta and every pool path management cycle Tb in accordance with the optical path generation time, and a timing of setting thereof is controlled by an adjustment of the threshold TH. In each of examples below, it is assumed that a band of each optical path is 10 Gbps, the default path management cycle Ta is one month, and the pool path management cycle Tb is one day.

### FIRST EXAMPLE

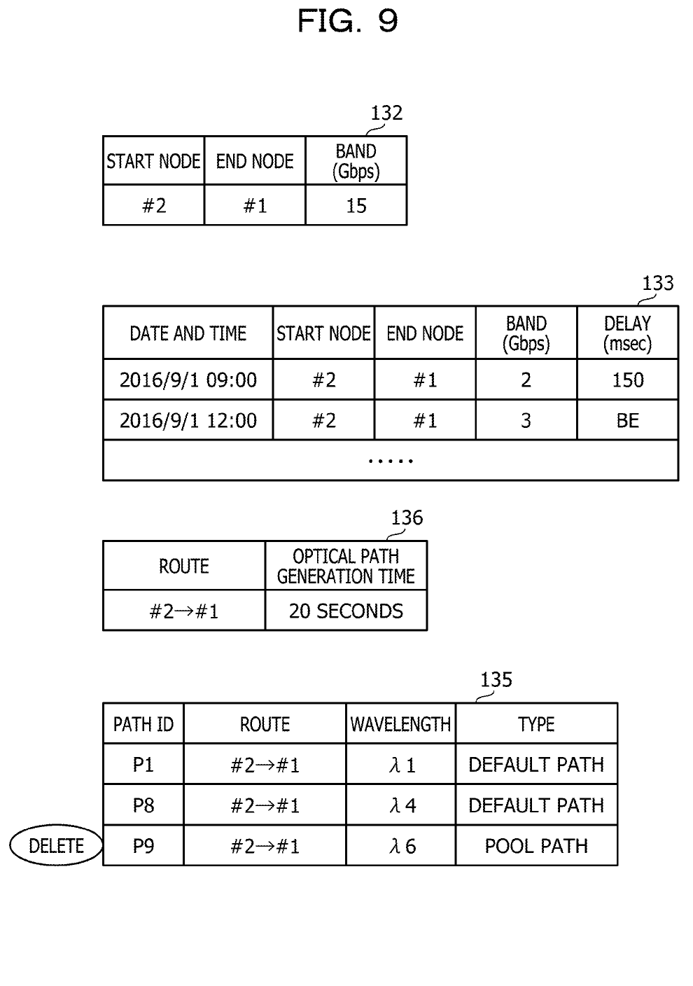

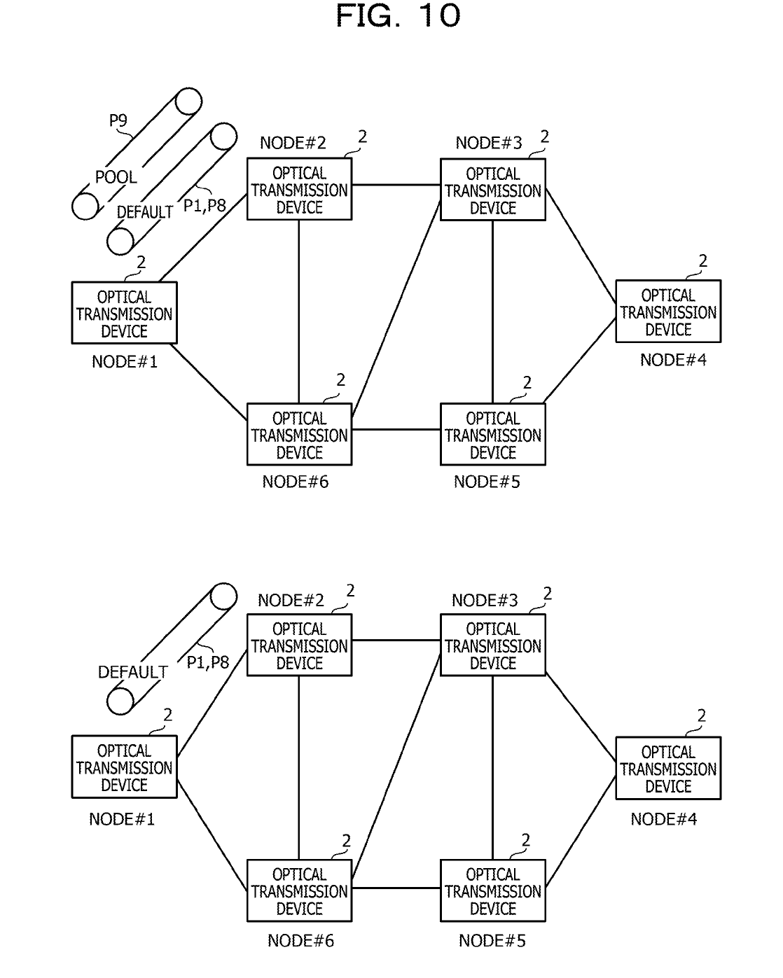

FIG. 9 and FIG. 10 are charts illustrating a first example of the optical path management operation. In this example, a case in which, because the predicted band of a demand is sufficiently larger than the occurrence band, a band of a pool path P9 still remains, and, because the optical path generation time is shorter than an average time interval of occurrence of a demand, the pool path P9 is deleted will be described. In this example, a route that connects the start node #2 and the end node #1 will be described.

In FIG. 9, the demand prediction information DB 132, the demand occurrence information DB 133, the optical path generation time DB 136, and the optical path management DB 135 are illustrated. In upper chart of FIG. 10, an image of an optical path that connects the start node #2 and the end node #1 before deletion of the pool path P9. In lower chart of FIG. 10, an image of the optical path that connects the start node #2 and the end node #1 after deletion of the pool path P9.

With reference to FIG. 9, 15 Gbps is registered as the predicted band in the demand prediction information DB 132. Then, the total 5 Gbps (=2 +3) is registered as the occurrence band in the demand occurrence information DB 133. In the route that connects the start node #2 and the end node #1, default paths P1 and P8 (see upper chart of FIG. 10) are set in accordance with 15 Gbps of the predicted band, and furthermore, the pool path P9 is set. Therefore, in the optical path management DB 135, the default paths P1 and P8 and the pool path P9 are registered.

The optical path setting processing unit 104 calculates the ratio of the occurrence band to the predicted band and compares the ratio to the certain value Kb. The ratio of the occurrence band to the predicted band is about 0.3 (=5/15). Thus, assuming that the certain value Kb=1, the ratio of the occurrence band to the predicted band Kb. Therefore, the optical path setting processing unit 104 determines that the predicted band of a demand is sufficiently larger than the occurrence band.

The optical path setting processing unit 104 acquires the average time interval of occurrence of a demand, for example, from a date and time at which a demand has occurred, which is registered in the demand occurrence information DB 133, and acquires the optical path generation time from the optical path generation time DB 136. The optical path setting processing unit 104 determines whether the optical path generation time is long or short by comparing the average time interval of occurrence of a demand and the optical path generation time to one another. In FIG. 9, illustration of demand information used for calculating the average time interval of occurrence of a demand is omitted for convenience purposes.

For example, assuming that the average time interval of occurrence of a demand is 60 seconds, the optical path generation time is 20 seconds (<60 seconds). Therefore, the optical path setting processing unit 104 determines that the optical path generation time is short.

As described above, the predicted band of a demand is sufficiently larger than the occurrence band and the optical path generation time is short. Thus, as illustrated in lower chart of FIG. 10, the optical path setting processing unit 104 deletes the unused pool path P9. In this case, the optical path setting processing unit 104 instructs each of the optical transmission devices 2 of the start node #2 and the end node #1 to delete the pool path P9. After the deletion, as illustrated in FIG. 9, the optical path setting processing unit 104 deletes information of the pool path P9 from the optical path management DB 135.

Thus, in the node #1 and the node #2, the wavelength λ6 of the pool path P9 is ensured for a new demand in which another route is specified.

### SECOND EXAMPLE

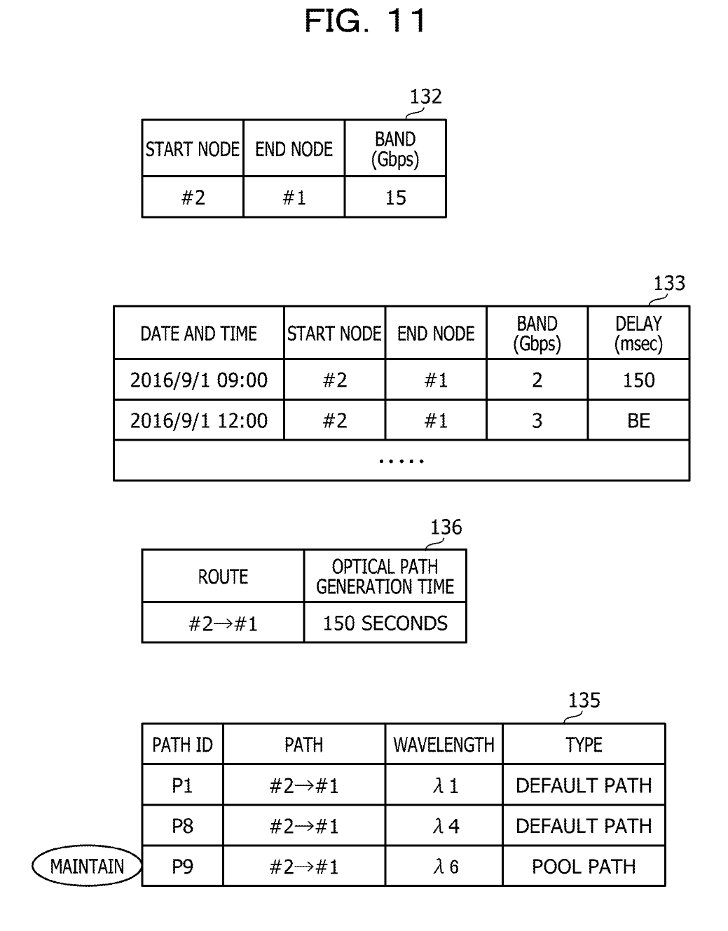

FIG. 11 is a chart illustrating a second example of the optical path management operation. In this example, a case in which, because the predicted band of a demand is sufficiently larger than the occurrence band, the band of the pool path P9 still remains and, because the optical path generation time is longer than the average time interval of occurrence of a demand, the pool path P9 is maintained will be described. In this example, a route that connects the start node #2 and the end node #1 will be described.

In FIG. 11, the demand prediction information DB 132, the demand occurrence information DB 133, the optical path generation time DB 136, and the optical path management DB 135 are illustrated. In this example, the optical path generation time is 150 seconds, which is different from that in the first example, but conditions of various other types are the same as those in the first example. Therefore, for example, assuming that the average time interval of occurrence of a demand is 60 seconds, the optical path generation time is 150 seconds (>60 seconds). Therefore, the optical path setting processing unit 104 determines that the optical path generation time is long.

As described above, because the predicted band of a demand is sufficiently larger than the occurrence band and the optical path generation time is long, the optical path setting processing unit 104 maintains the unused pool path P9. Thus, even when a new demand occurs, the network monitoring control device 1 is able to provide the pool path P9 in a timely manner in accordance with the demand. In contrast, if the pool path P9 is deleted, because the optical path generation time is long, after occurrence of a demand, the pool path P9 is not immediately regenerated and a call loss might occur.

### THIRD EXAMPLE

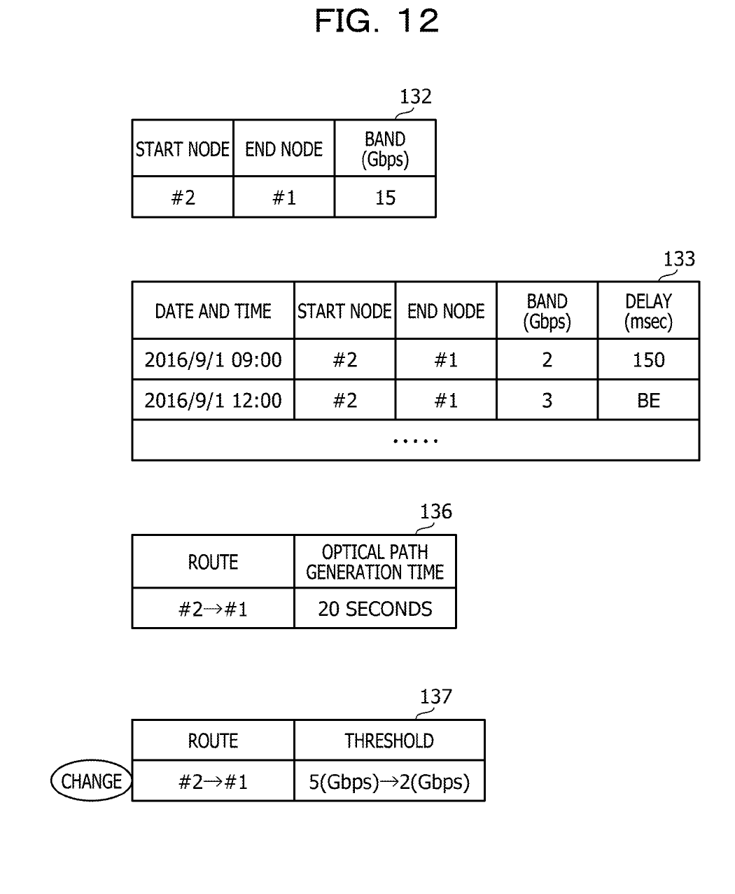

FIG. 12 is a chart illustrating a third example of the optical path management operation. In this example, because the optical path generation time is shorter than the average time interval of occurrence of a demand, the optical path setting parameter control unit 105 reduces the threshold TH of the total of available bands, which is a setting condition for a pool path in the St59 described above, to thereby delay an optical path setting timing. In this example, a route that connects the start node #2 and the end node #1 will be described.

In FIG. 12, the demand prediction information DB 132, the demand occurrence information DB 133, the optical path generation time DB 136, and the threshold DB 137 are illustrated. In this example, the predicted band of a demand is sufficiently larger than the occurrence band. Conditions of various types in this example are the same as those in the first example. For example, assuming that the average time interval of occurrence of a demand is 60 seconds, the optical path generation time is 20 seconds (<60 seconds), and therefore, the optical path setting processing unit 104 determines that the optical path generation time is short.

The optical path setting parameter control unit 105 delays the optical path setting timing by reducing the threshold TH in accordance with a result of the above-described determination. More specifically, the optical path setting parameter control unit 105 changes the threshold TH from 5 Gbps to 2 Gbps. Therefore, the optical path setting processing unit 104 adds a pool path at a timing later than a timing at which the entire available band becomes 5 Gbps, that is, at a timing at which the entire available band becomes 2 Gbps.

As described above, if the optical path generation time is short, the optical path setting parameter control unit 105 delays a pool path setting timing. In this case, even when a new demand occurs, a call loss does not occur because the optical path generation time is short. Generation of a redundant pool path is reduced by delaying the pool path setting timing, and therefore, use efficiency of a wavelength resource in the network NW is increased.

### FOURTH EXAMPLE

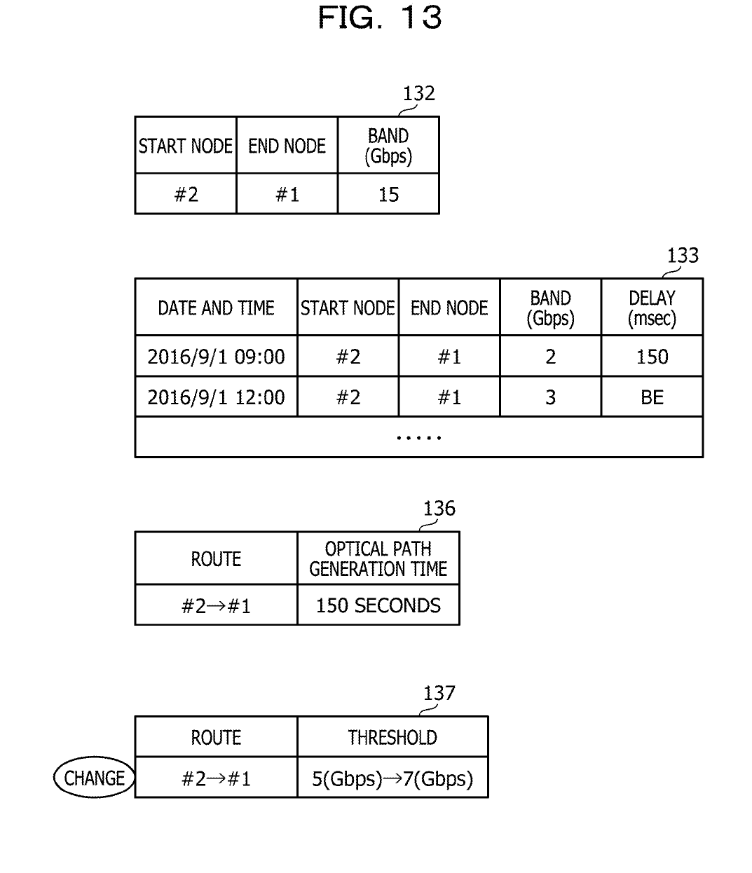

FIG. 13 is a chart illustrating a fourth example of the optical path management operation. In this example, the optical path generation time is longer than the average time interval of occurrence of a demand. Therefore, the optical path setting parameter control unit 105 advances the optical path setting timing by increasing the threshold TH of the total of available bands, which is a setting condition for a pool path in St59 described above. In this example, a route that connects the start node #2 and the end node #1 will be described.

In FIG. 13, the demand prediction information DB 132, the demand occurrence information DB 133, the optical path generation time DB 136, and the threshold DB 137 are illustrated. Conditions of various types in this example are the same as those in the third example, except for the threshold TH. For example, assuming that the average time interval of occurrence of a demand is 60 seconds, the optical path generation time is 150 seconds (>60 seconds). Therefore, the optical path setting processing unit 104 determines that the optical path generation time is long.

The optical path setting parameter control unit 105 delays the optical path setting timing by increasing the threshold TH in accordance with a result of the above-described determination. More specifically, the optical path setting parameter control unit 105 changes the threshold TH from 5 Gbps to 7 Gbps. Therefore, the optical path setting processing unit 104 adds a pool path at a timing earlier than a timing at which the entire available band becomes 5 Gbps, that is, at a timing at which the entire available band becomes 7 Gbps.

As described above, if the optical path generation time is long, the optical path setting parameter control unit 105 advances the pool path setting timing. Therefore, although the optical path generation time is long, in expectation of occurrence of a demand, a pool path is set at an earlier timing, and therefore, a call loss does not occur.

### FIFTH EXAMPLE

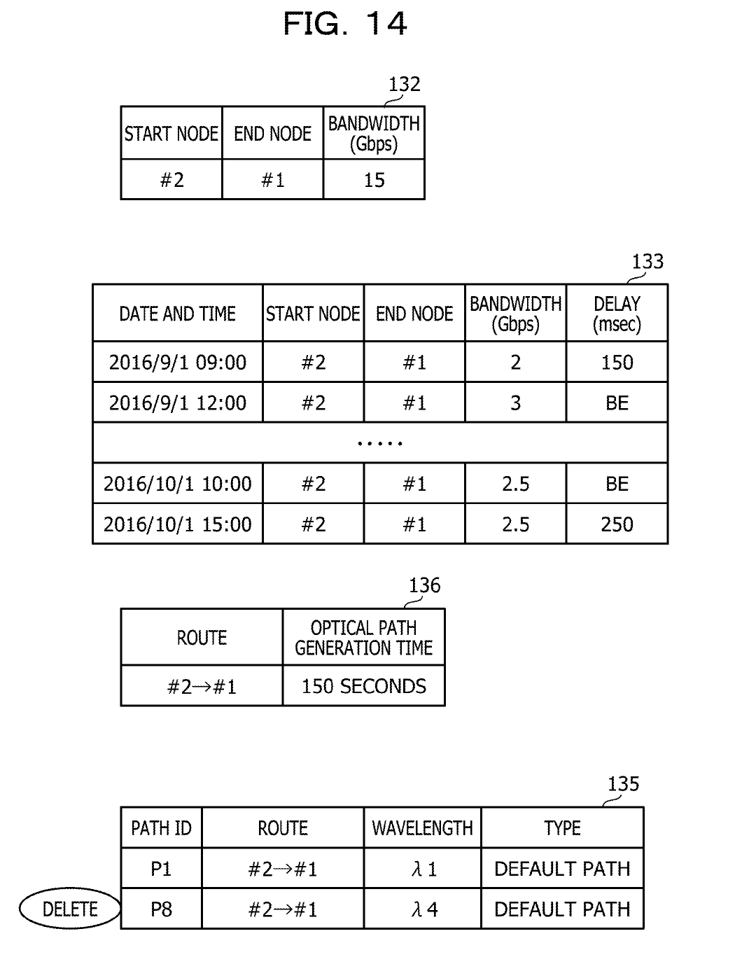

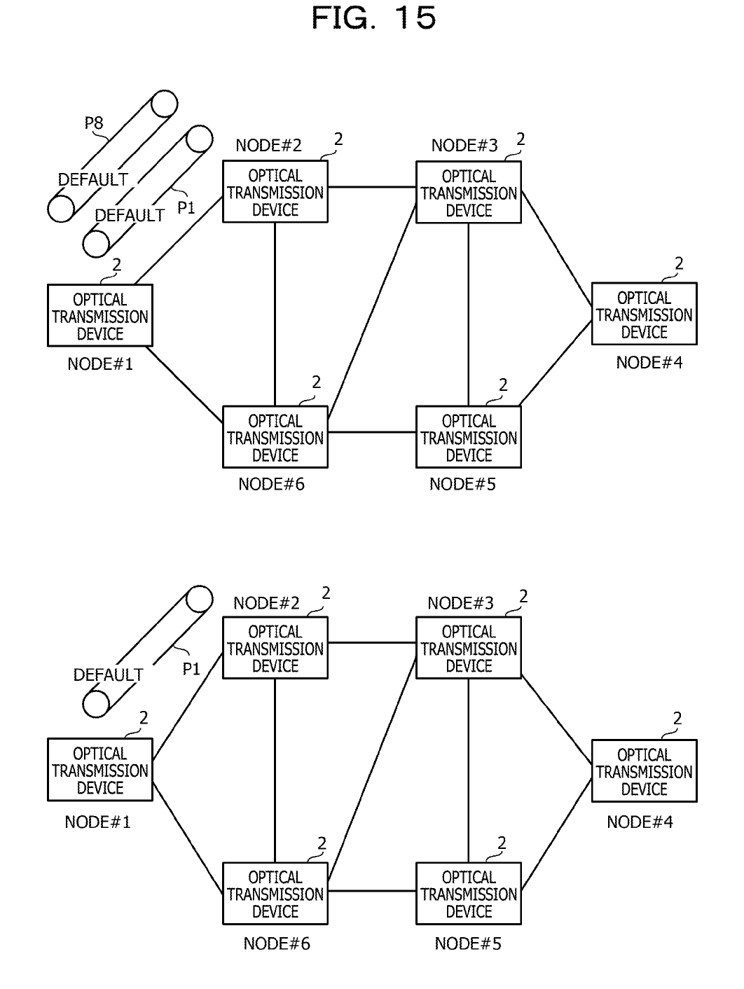

FIG. 14 and FIG. 15 are charts illustrating a fifth example of the optical path management operation. In this example, a case in which, because the predicted band of a demand is sufficiently larger than the occurrence band, bands of the default paths P1 and P8 still remain, it is determined that the demand occurrence state continues entirely during the default path management cycle Ta, and therefore, a single default path P8 is deleted will be described. In this example, a route that connects the start node #2 and the end node #1 will be described.

In FIG. 14, the demand prediction information DB 132, the demand occurrence information DB 133, the optical path generation time DB 136, and the optical path management DB 135 are illustrated. In upper chart of FIG. 15, an image of an optical path that connects the start node #2 and the end node #1 before deletion of the default path P8 is illustrated. In lower chart of FIG. 15, an image of the optical path that connects the start node #2 and the end node #1 after deletion of the default path P8 is illustrated.

With reference to FIG. 14, 15 Gbps is registered as the predicted band in the demand prediction information DB 132. Then, the default paths P1 and P8 (see upper chart of FIG. 15) are set in the route that connects the start node #2 and the end node #1 in accordance with 15 Gbps of the predicted band. Therefore, in the optical path management DB 135, the default paths P1 and P8 are registered.

In this example, as an example, a time point (2016/10/1 (October 1^{st}, 2016)) after one month has elapsed since a time point (2016/9/1 (September 1^{st}, 2016)) in the first example is assumed. In the demand occurrence information DB 133, for a date and time of “2016/10/1”, the total 5 Gbps (=2.5 +2.5) is registered as the occurrence band. Illustration of demand occurrence information of the date and time between “2016/9/1” and “2016/10/1” is omitted.

The optical path setting processing unit 104 calculates the ratio of the occurrence band to the predicted band and compares the ratio to the certain value Kb. The ratio of the occurrence band to the predicted band is about 0.3 (=5/15). Therefore, assuming that the certain value Kb=1, the ratio of the occurrence band to the predicted band Kb. Therefore, the optical path setting processing unit 104 determines that the predicted band of a demand is sufficiently larger than the occurrence band.

As a result of reference to the demand occurrence information DB 133, for example, if there is not a date in which the total of the occurrence band is larger than 5 Gbps in one month from “2016/9/1” to “2016/10/1”, the optical path setting processing unit 104 determines that there is continuity in a state in which the predicted band of a demand is sufficiently larger than the occurrence band. That is, the optical path setting processing unit 104 determines, based on a demand history, that there is continuity in a demand occurrence state.

The optical path setting processing unit 104, for example, acquires the average time interval of occurrence of a demand from the date and time at which a demand has occurred, which is registered in the demand occurrence information DB 133, and acquires the optical path generation time from the optical path generation time DB 136. The optical path setting processing unit 104 determines, by comparing the average time interval of occurrence of a demand and the optical path generation time to one another, whether the optical path generation time is long or short. In FIG. 14, illustration of demand information used for calculating the average time interval of occurrence of a demand is omitted for convenience purposes.

For example, assuming that the average time interval of occurrence of a demand is 60 seconds, the optical path generation time is 150 seconds (>60 seconds). Therefore, the optical path setting processing unit 104 determines that the optical path generation time is long.

As described above, because the predicted band of a demand is sufficiently larger than the occurrence band and there is continuity in the occurrence state, even when the optical path setting processing unit 104 has determined that the optical path generation time is long, as illustrated in lower chart of FIG. 15, the optical path setting processing unit 104 deletes the unused pool path P8. In this case, the optical path setting processing unit 104 instructs each of the optical transmission devices 2 of the start node #2 and the end node #1 to delete the pool path P8. After the deletion, as illustrated in FIG. 14, the optical path setting processing unit 104 deletes information of the pool path P8 from the optical path management DB 135.

Thus, in the node #1 and the node #2, the wavelength λ4 of the pool path P8 is ensured for a new demand in which another route is specified.

### SIXTH EXAMPLE

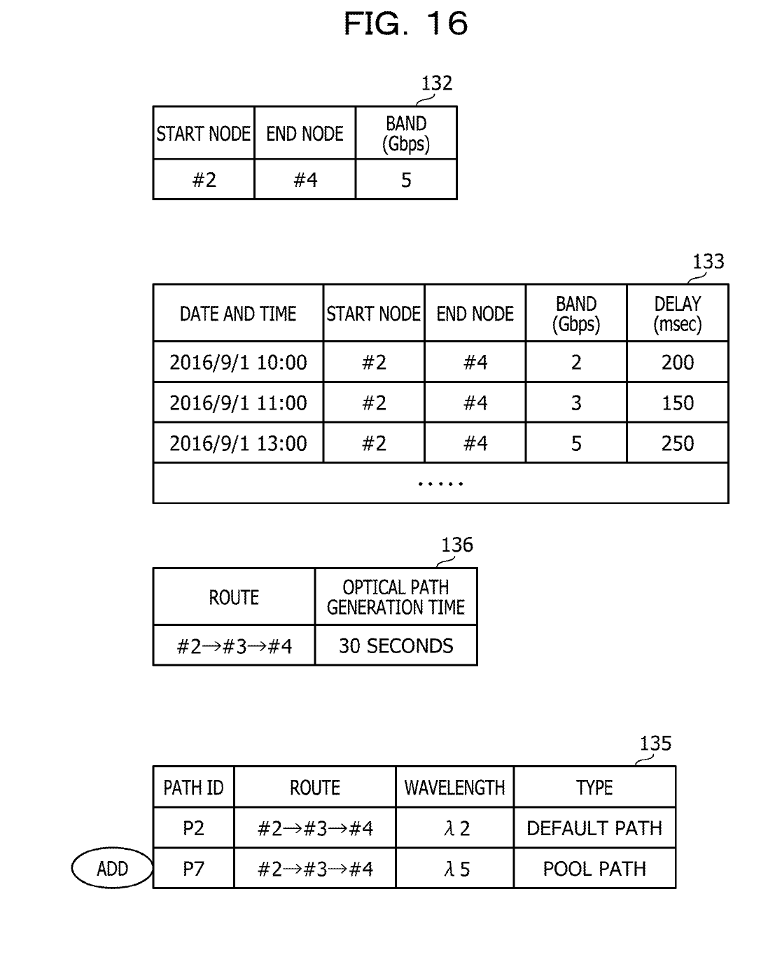

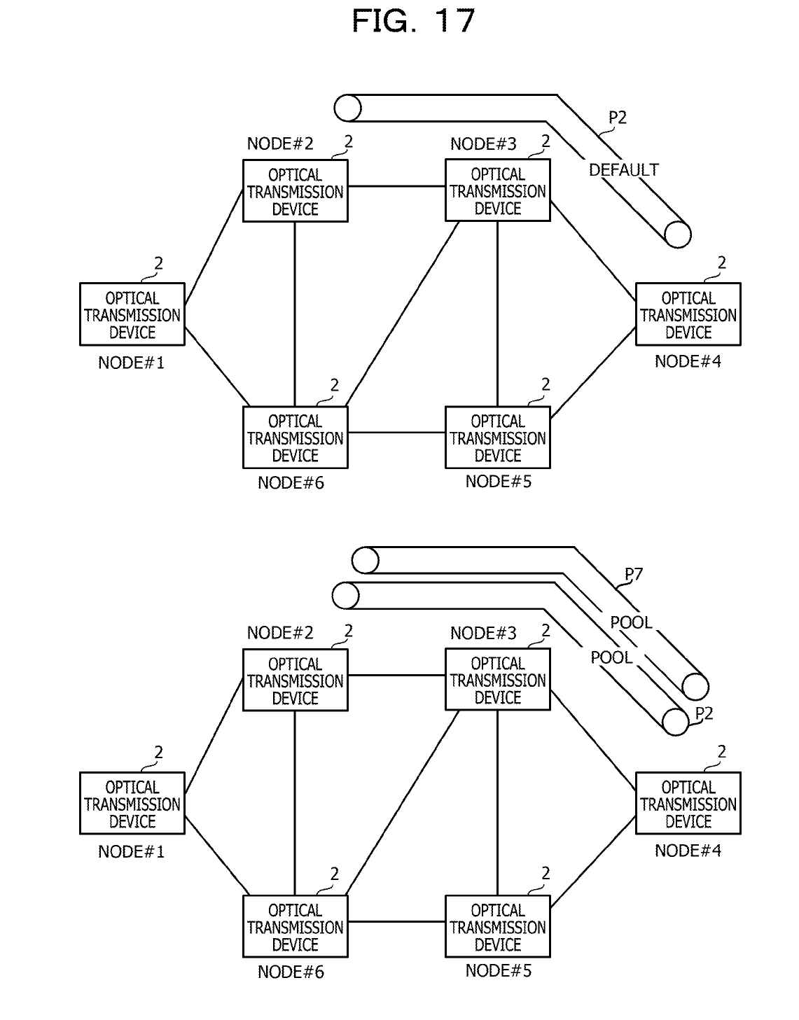

FIG. 16 and FIG. 17 are charts illustrating a sixth example of the optical path management operation. In this example, a case in which, because the predicted band of a demand is sufficiently smaller than the occurrence band, the available band of a default path P2 is small and, because the optical path generation time is shorter than the average time interval of occurrence of a demand, only a single pool path P7 is added will be described. In this example, a route that connects the start node #2, the relay node #3, and the end node #4 will be described.

In FIG. 16, the demand prediction information DB 132, the demand occurrence information DB 133, the optical path generation time DB 136, and the optical path management DB 135 are illustrated. In upper chart of FIG. 17, an image of an optical path that connects the start node #2, the relay node #3, and the end node #4 before addition of the pool path P7 is illustrated. In lower chart of FIG. 17, an image of the optical path that connects the start node #2, the relay node #3, and the end node #4 after addition of the pool path P7 is illustrated.

With reference to FIG. 16, 5 Gbps is registered as the predicted band in the demand prediction information DB 132. Then, the total 10 Gbps (=2+3+5) is registered as the occurrence band in the demand occurrence information DB 133. The default path P2 (see upper chart of FIG. 17) is set in the route that connects the start node #2, the relay node #3, and the end node #4 in accordance with 5 Gbps of the predicted band. Therefore, in the optical path management DB 135, the default path P2 is registered in an initial state. The pool path P7 is additionally registered later.

The optical path setting processing unit 104 calculates the ratio of the occurrence band to the predicted band and compares the ratio to the certain value Ka. Because the ratio of the occurrence band to the predicted band is 2 (=10/5), assuming that the certain value Ka=1.5, the ratio of the occurrence band to the predicted band Ka. Therefore, the optical path setting processing unit 104 determines that the predicted band of a demand is sufficiently smaller than the occurrence band.

The optical path setting processing unit 104, for example, acquires the average time interval of occurrence of a demand from the date and time at which a demand has occurred, which is registered in the demand occurrence information DB 133, and acquires the optical path generation time from the optical path generation time DB 136. The optical path setting processing unit 104 determines, by comparing the average time interval of occurrence of a demand and the optical path generation time to one another, whether the optical path generation time is long or short. In FIG. 16, illustration of demand information used for calculating the average time interval of occurrence of a demand is omitted for convenience purposes.

For example, assuming that the average time interval of occurrence of a demand is 90 seconds, the optical path generation time is 30 seconds (<90 seconds), and therefore, the optical path setting processing unit 104 determines that the optical path generation time is short.

As described above, because the predicted band of a demand is sufficiently shorter than the occurrence band and the optical path generation time is short, as illustrated in lower chart of FIG. 17, the optical path setting processing unit 104 adds only a single pool path P7. In this case, the optical path setting processing unit 104 instructs each of the optical transmission devices 2 of the start node #2, the relay node #3, and the end node #4 to generate the pool path P7. After the addition, as illustrated in FIG. 16, the optical path setting processing unit 104 registers information of the pool path P7 in the optical path management DB 135.

Therefore, the network monitoring control device 1 is able to prepare an appropriate number (one in this case) of pool paths P7 in accordance with the optical path generation time in advance of occurrence of a demand.

### SEVENTH EXAMPLE

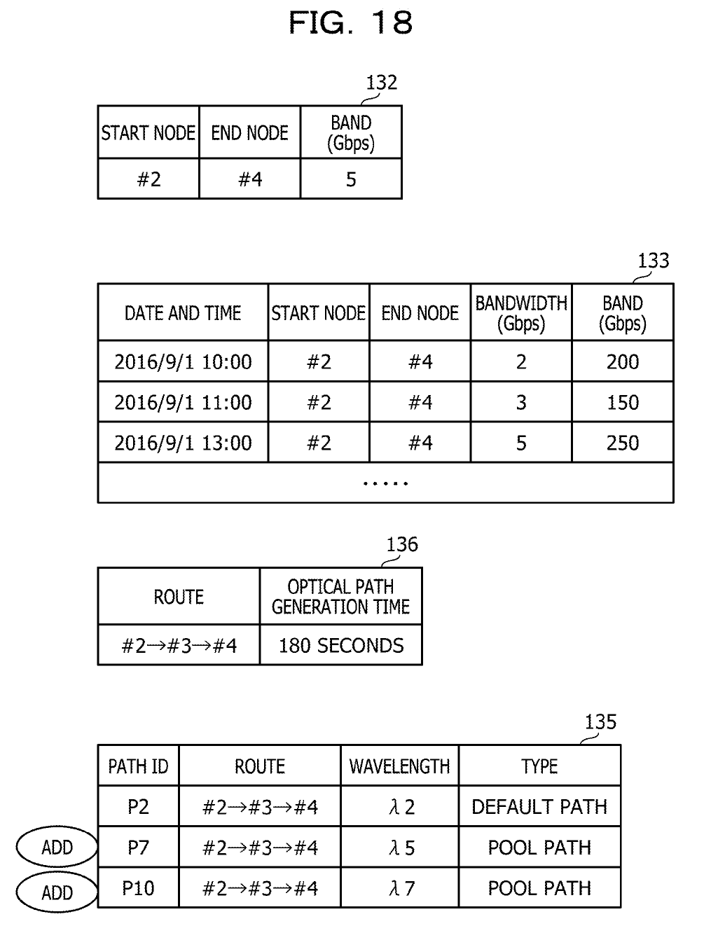

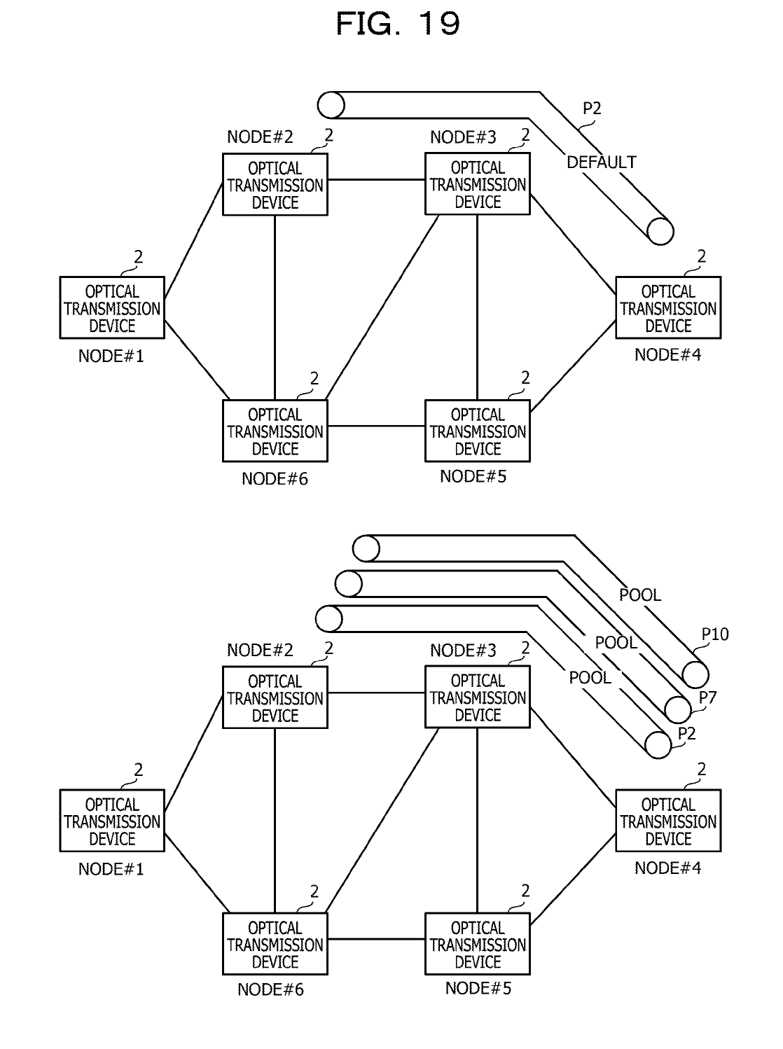

FIG. 18 and FIG. 19 are charts illustrating a seventh example of the optical path management operation. In this example, a case in which, because the predicted band of a demand is sufficiently smaller than the occurrence band, the available band of the default path P2 is small and, because the optical path generation time is longer than the average time interval of occurrence of a demand, two pool paths P7 and P10 are added will be described. In this example, a route that connects the start node #2, the relay node #3, and the end node #4 will be described.

In FIG. 18, the demand prediction information DB 132, the demand occurrence information DB 133, the optical path generation time DB 136, and the optical path management DB 135 are illustrated. In upper chart of FIG. 19, an image of an optical path that connects the start node #2, the relay node #3, and the end node #4 before addition of the pool paths P7 and P10 is illustrated. In lower chart of FIG. 19, an image of the optical path that connects the start node #2, the relay node #3, and the end node #4 after addition of the pool paths P7 and P10 is illustrated.

In this case, unlike the sixth example, the optical path generation time is 180 seconds, but conditions of various other types are the same as those in the sixth example. Therefore, for example, assuming that the average time interval of occurrence of a demand is 90 seconds, the optical path generation time is 180 seconds (>90 seconds). Therefore, the optical path setting processing unit 104 determines that the optical path generation time is long.

As described above, because the predicted band of a demand is sufficiently shorter than the occurrence band and the optical path generation time is long, as illustrated in lower chart of FIG. 19, the optical path setting processing unit 104 adds two pool paths P7 and P10. In this case, the optical path setting processing unit 104 instructs each of the optical transmission devices 2 of the start node #2, the relay node #3, and the end node #4 to generate the pool paths P7 and P10. After the addition, as illustrated in FIG. 18, the optical path setting processing unit 104 registers information of the pool paths P7 and P10 in the optical path management DB 135.

Therefore, the network monitoring control device 1 is able to prepare an appropriate number (two in this case) of pool paths P7 and P10 in accordance with the optical path generation time in advance of occurrence of a demand.

### EIGHTH EXAMPLE

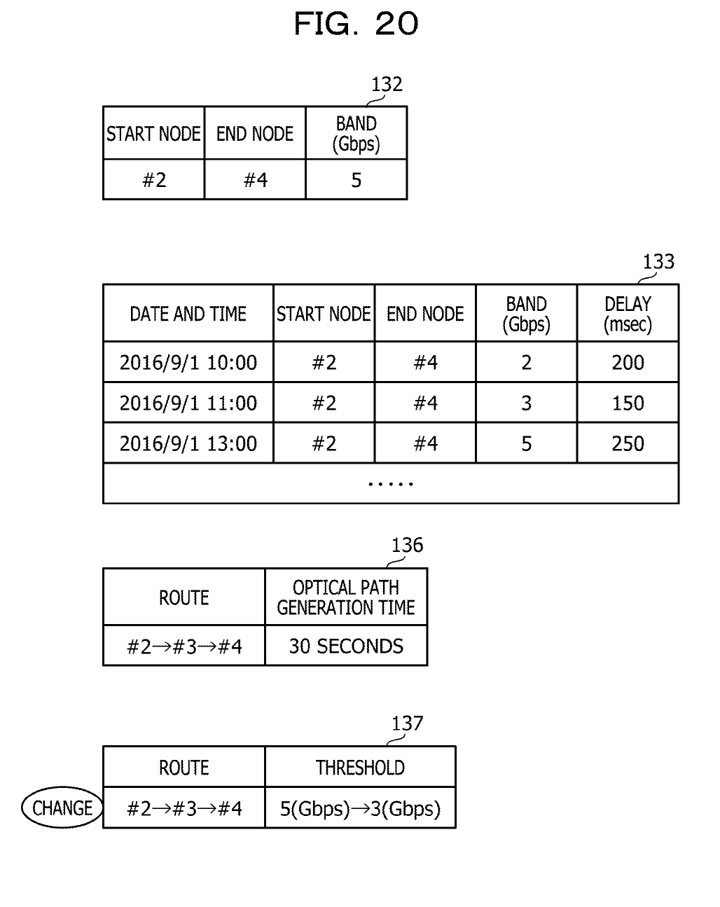

FIG. 20 is a chart illustrating an eighth example of the optical path management operation. In this example, the optical path generation time is shorter than the average time interval of occurrence of a demand. Therefore, the optical path setting parameter control unit 105 delays the optical path setting timing by reducing the threshold TH of the total of available bands, which is a setting condition for a pool path in St59 described above. In this example, a route that connects the start node #2, the relay node #3, and the end node #4 will be described.

In FIG. 20, the demand prediction information DB 132, the demand occurrence information DB 133, the optical path generation time DB 136, and the threshold DB 137 are illustrated. The predicted band of a demand is sufficiently smaller than the occurrence band. Conditions of various types in this example are the same as those in the sixth example. For example, assuming that the average time interval of occurrence of a demand is 90 seconds, the optical path generation time is 30 seconds (<90 seconds). Therefore, the optical path setting processing unit 104 determines that the optical path generation time is short.

The optical path setting parameter control unit 105 delays the optical path setting timing by reducing the threshold TH in accordance with a result of the above-described determination. More specifically, the optical path setting parameter control unit 105 changes the threshold TH from 5 Gbps to 3 Gbps. Therefore, the optical path setting processing unit 104 adds a pool path at a timing later than a timing at which the entire available band becomes 5 Gbps, that is, at a timing at which the entire available band becomes 3 Gbps.

As described above, if the optical path generation time is short, the optical path setting parameter control unit 105 delays the pool path setting timing. In this case, even when a new demand occurs, a call loss does not occur because the optical path generation time is short. Generation of a redundant pool path is reduced by delaying the pool path setting timing. Therefore, use efficiency of a wavelength resource in the network NW is increased.

### NINTH EXAMPLE

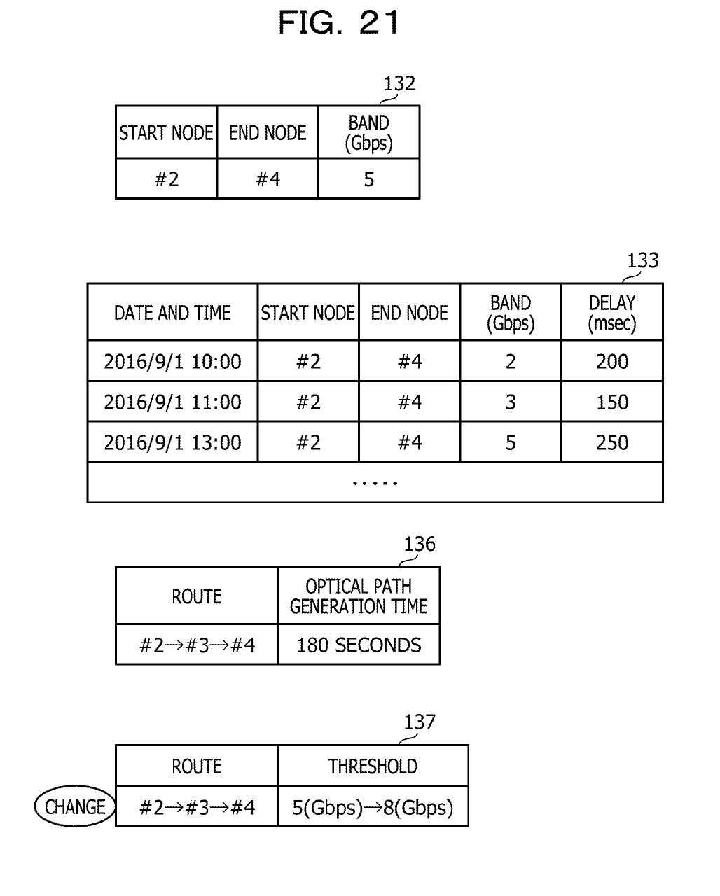

FIG. 21 is a chart illustrating a ninth example of the optical path management operation. In this example, the optical path generation time is longer than the average time interval of occurrence of a demand. Therefore, the optical path setting parameter control unit 105 advances the optical path setting timing by increasing the threshold TH of the total of available bands, which is a setting condition for a pool path in St59 described above. In this example, a route that connects the start node #2, the relay node #3, and the end node #4 will be described.

In FIG. 21, the demand prediction information DB 132, the demand occurrence information DB 133, the optical path generation time DB 136, and the threshold DB 137 are illustrated. The predicted band of a demand is sufficiently smaller than the occurrence band. Conditions of various types in this example are the same as those in the sixth example, except for the threshold TH and the optical path generation time. For example, assuming that the average time interval of occurrence of a demand is 90 seconds, the optical path generation time is 180 seconds (>90 seconds). Therefore, the optical path setting processing unit 104 determines that the optical path generation time is long.

The optical path setting parameter control unit 105 advances the optical path setting timing by increasing the threshold TH in accordance with a result of the above-described determination. More specifically, the optical path setting parameter control unit 105 changes the threshold TH from 5 Gbps to 8 Gbps. Therefore, the optical path setting processing unit 104 adds a pool path at a timing earlier than a timing at which the entire available band becomes 5 Gbps, that is, at a timing at which the entire available band becomes 8 Gbps.

As described above, if the optical path generation time is long, the optical path setting parameter control unit 105 advances the pool path setting timing. Therefore, although the optical path generation time is long, in expectation of occurrence of a demand, a pool path is set at an earlier timing, and therefore, a call loss does not occur.

### TENTH EXAMPLE

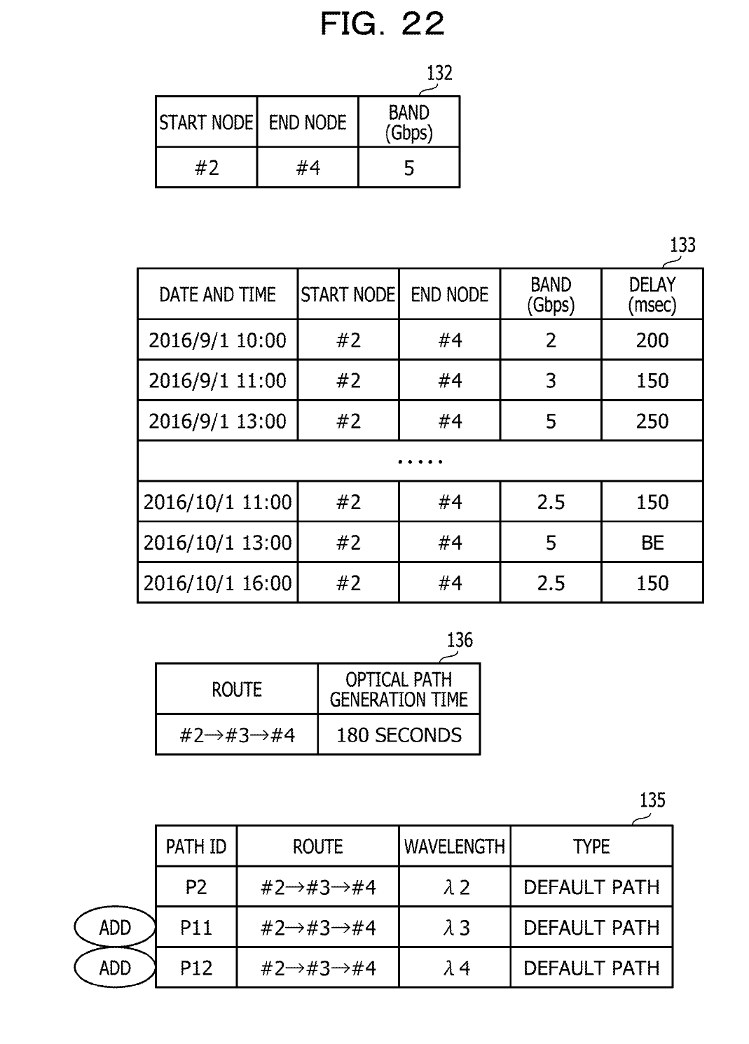

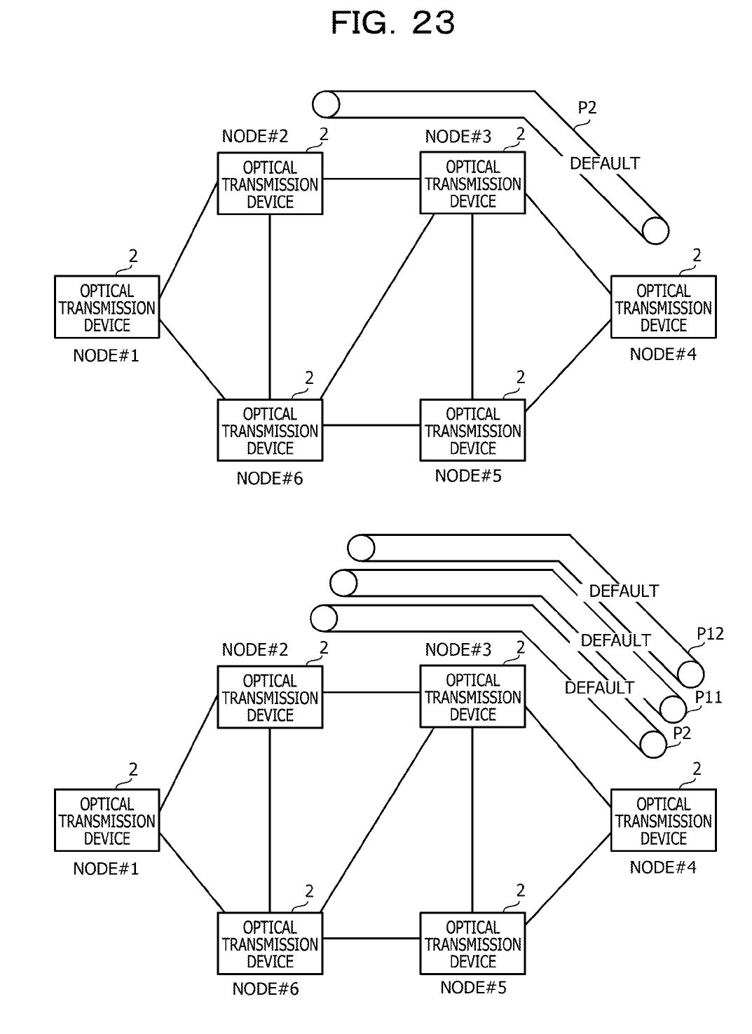

FIG. 22, FIG. 23A, and FIG. 23B are charts illustrating a tenth example of the optical path management operation. In this example, a case in which, because the predicted band of a demand is sufficiently smaller than the occurrence band, the available band of the default path P2 is small, it is determined that the demand occurrence state continues entirely during the default path management cycle Ta, and therefore, two default paths P11 and P12 are added will be described. In this example, a route that connects the start node #2, the relay node #3, and the end node #4 will be described.

In FIG. 22, the demand prediction information DB 132, the demand occurrence information DB 133, the optical path generation time DB 136, and the optical path management DB 135 are illustrated. In FIG. 23A, an image of an optical path that connects the start node #2, the relay node #3, and the end node #4 before addition of the default paths P11 and P12 is illustrated. In FIG. 23B, an image of the optical path that connects the start node #2, the relay node #3, and the end node #4 after addition of the default paths P11 and P12 is illustrated.

With reference to FIG. 22, 5 Gbps is registered as the predicted band in the demand prediction information DB 132. Then, the default path P2 (see FIG. 23A) is set in the route that connects the start node #2, the relay node #3, and the end node #4 in accordance with 5 Gbps of the predicted band. Therefore, in the optical path management DB 135, the default path P2 is registered. The default paths P11 and P12 are added later.

In this example, as an example, a time point (2016/10/1 (October 1^{st}, 2016)) after one month has elapsed since a time point (2016/9/1 (September 1^{st}, 2016)) in the sixth example is assumed. In the demand occurrence information DB 133, for the date and time of “2016/10/1”, the total 10 Gbps (=2.5+5+2.5) is registered as the occurrence band. Illustrating of demand occurrence information of the date and time between “2016/9/1” to “2016/10/1” is omitted.

The optical path setting processing unit 104 calculates the ratio of the occurrence band to the predicted band and compares the ratio to the certain value Ka. The ratio of the occurrence band to the predicted band is 2 (=10/5). Thus, assuming that the certain value Ka=1.5, the ratio of the occurrence band to the predicted band Ka. Therefore, the optical path setting processing unit 104 determines that the predicted band of a demand is sufficiently smaller than the occurrence band.

As a result of reference to the demand occurrence information DB 133, for example, if there is not a date in which the total of the occurrence band is smaller than 10 Gbps in one month from “2016/9/1” to “2016/10/1”, the optical path setting processing unit 104 determines that there is continuity in a state in which the predicted band of a demand is sufficiently smaller than the occurrence band. That is, the optical path setting processing unit 104 determines, based on a demand history, that there is continuity in a demand occurrence state.

The optical path setting processing unit 104, for example, acquires the average time interval of occurrence of a demand from the date and time at which a demand has occurred, which is registered in the demand occurrence information DB 133, and acquires the optical path generation time from the optical path generation time DB 136. The optical path setting processing unit 104 determines, by comparing the average time interval of occurrence of a demand and the optical path generation time to one another, whether the optical path generation time is long or short. In FIG. 22, illustration of demand information used for calculating the average time interval of occurrence of a demand is omitted for convenience purposes.

For example, assuming that the average time interval of occurrence of a demand is 90 seconds, the optical path generation time is 180 seconds (>90 seconds). Therefore, the optical path setting processing unit 104 determines that the optical path generation time is long.

As described above, because the predicted band of a demand is sufficiently smaller than the occurrence band, there is continuity in the demand occurrence state, and furthermore, the optical path generation time is long, as illustrated in FIG. 23B, the optical path setting processing unit 104 adds two default paths P11 and P12. In this case, the optical path setting processing unit 104 instructs each of the optical transmission devices 2 of the start node #2, the relay node #3, and the end node #4 to add the default paths P11 and P12. After the addition, as illustrated in FIG. 22, the optical path setting processing unit 104 adds information of the default paths P11 and P12 in the optical path management DB 135.

As described above, if the optical path generation time is long, the optical path setting processing unit 104 adds a default path. Therefore, although the optical path generation time is long, in expectation of occurrence of a demand, a default path is set, and therefore, a call loss does not occur.

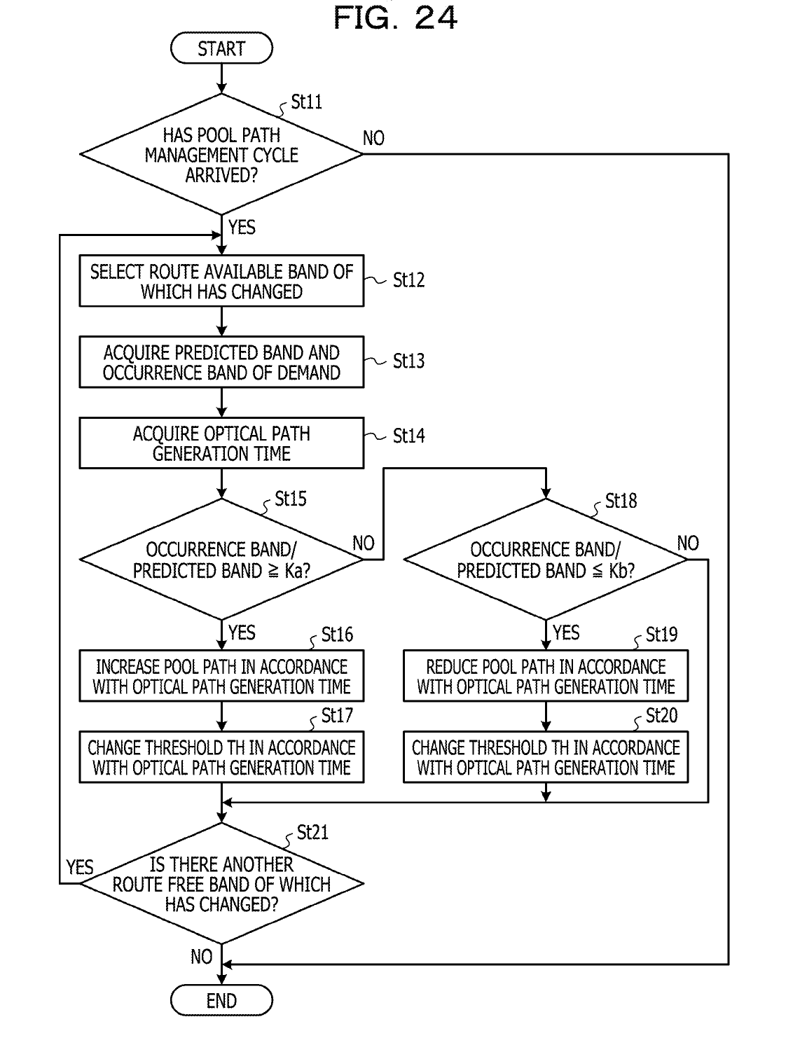

FIG. 24 is a flowchart illustrating an example of pool path management processing. A period in which pool path management processing is executed is an example of a first period and is shorter than a period of the default path management cycle Ta. That is, the period of default path management processing is longer than the period of pool path management processing.

The operation control unit 100 determines whether or not there has been change in available band of an optical path, as compared to a time point of previous pool path management processing (St11). If there has not been change in available band of an optical path (NO in St11), the process ends. Change in available band occurs, for example, due to generation or deletion of a line path.

If there has been change in available band of an optical path (YES in St11), the optical path setting processing unit 104 selects, from the line management DB 134 and the optical path management DB 135, a route the available band of which has changed (St12). Next, the optical path setting processing unit 104 acquires, for the route, the predicted band and the occurrence band from the demand prediction information DB 132 and the demand occurrence information DB 133, respectively (St13). Next, the optical path setting processing unit 104 acquires, for the route, the optical path generation time from the optical path generation time DB 136 (St14).

Next, the optical path setting processing unit 104 compares the ratio of the occurrence band to the predicted band to the certain value Ka (St15). If the ratio is the certain value Ka or more (YES in St15), the optical path setting processing unit 104 increases the pool path in accordance with the optical path generation time (St16). Examples of this processing include the sixth example and the seventh example which have been described above.

Next, the optical path setting processing unit 104 changes the threshold TH in accordance with the optical path generation time (St17). Examples of this processing include the eighth example and the ninth example which have been described above.

Next, the optical path setting processing unit 104 determines whether or not there is another route the available band of which has changed, as compared to a time of arrival of the previous pool path management cycle Tb (St21). If there is not another route (NO in St21), the optical path setting processing unit 104 terminates the process and, if there is another route (YES in St21), the optical path setting processing unit 104 selects the another route (St12) and executes processing of St13 and subsequent processing.

If the ratio of the occurrence band to the predicted band is smaller than the certain value Ka (NO in St15), the optical path setting processing unit 104 compares the ratio to the certain value Kb (St18). If the ratio is larger than the certain value Kb (NO in St18), processing of St21 is executed. If the ratio is the certain value Kb or less (YES in St18), the optical path setting processing unit 104 reduces the pool path in accordance with the optical path generation time (St19). Examples of this processing include the first example and the second example which have been described above.

Next, the optical path setting processing unit 104 changes the threshold TH in accordance with the optical path generation time (St20). Examples of this processing include the third example and the fourth example which have been described above. Thereafter, processing of St21 is executed. In a manner described above, the pool path management processing is executed. With change in available band of an optical path as a trigger, pool path management processing of this example is executed. However, the pool path management processing is not limited thereto and may be executed with arrival of a certain cycle that is shorter than the default path management cycle Ta as a trigger.

As for St16 and St17 which have been described above, only one of St16 and St17 may be executed but, it is enabled by executing both of St16 and St17 to provide an optical path in a more timely manner in accordance with a demand. Similar applies to St19 and St20 which have been described above.

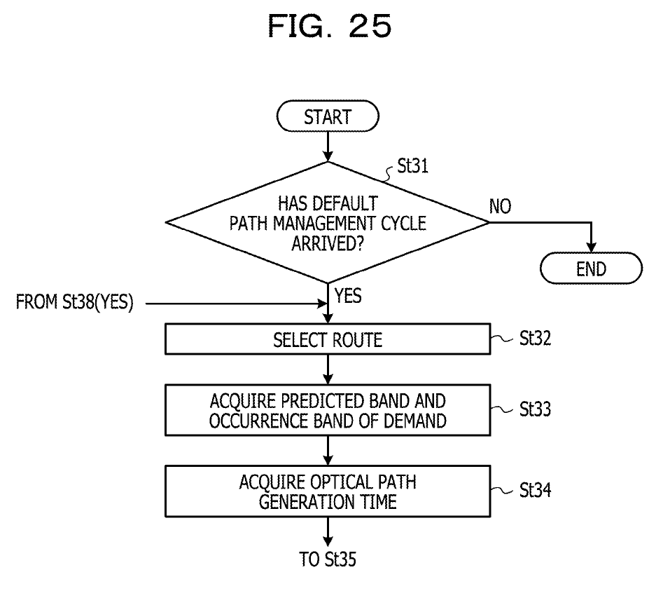

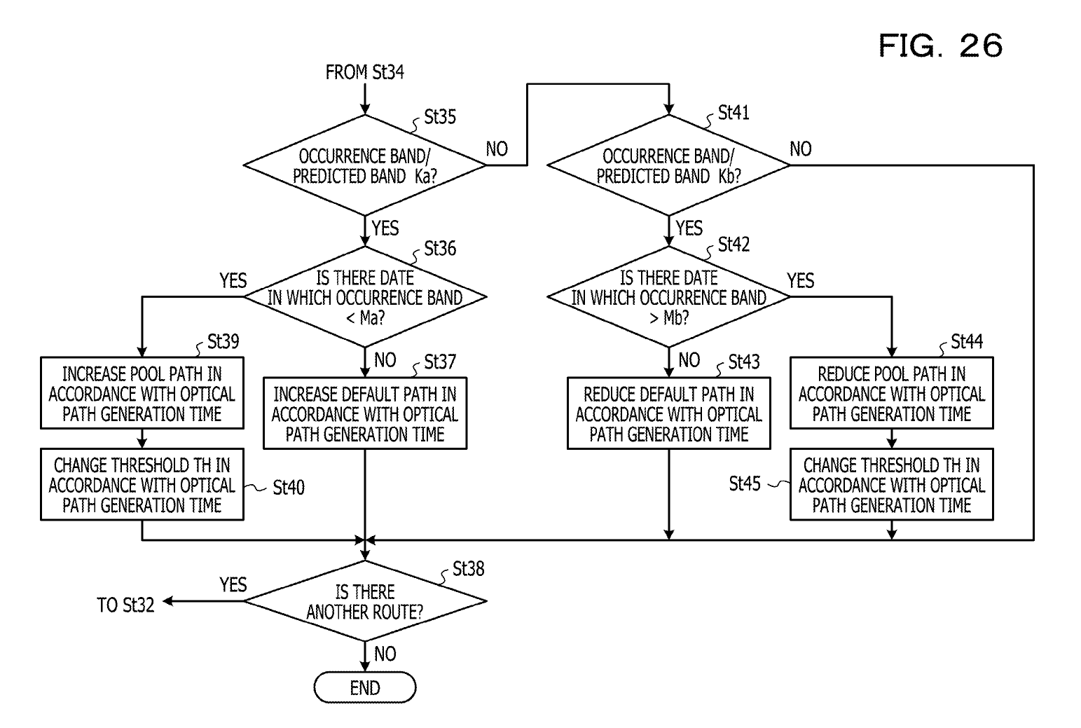

FIG. 25 and FIG. 26 are flowcharts illustrating an example of default path management processing. The operation control unit 100 determines whether or not the default path management cycle Ta has arrived (St31). If the default path management cycle Ta has not arrived (NO in St31), the process ends. The operation control unit 100 detects arrival of the default path management cycle Ta, for example, by a timer and notifies the optical path setting processing unit 104 of the arrival. A period in which default path management processing is executed is an example of a second period and is longer than an execution period of pool path management processing.

If the default path management cycle Ta has arrived (YES in St31), the optical path setting processing unit 104 selects a route from the network configuration DB 130 (St32). Next, the optical path setting processing unit 104 acquires, for the route, the predicted band and the occurrence band from the demand prediction information DB 132 and the demand occurrence information DB 133, respectively (St33). Next, the optical path setting processing unit 104 acquires, for the route, the optical path generation time from the optical path generation time DB 136 (St34).

Next, the optical path setting processing unit 104 compares the ratio of the occurrence band to the predicted band to the certain value Ka (St35). If the ratio is the certain value Ka or more (YES in St35), the optical path setting processing unit 104 determines, based on the demand occurrence information DB 133, whether or not there is a date in which the occurrence band is smaller than a certain value Ma in the current default path management cycle Ta (St36).

If there is a date in which the occurrence band is smaller than the certain value Ma (YES in St36), the optical path setting processing unit 104 increases the pool path in accordance with the optical path generation time (St39). Examples of this processing include the sixth example and the seventh example which have been described above.

Next, the optical path setting processing unit 104 changes the threshold TH in accordance with the optical path generation time (St40). Examples of this processing include the eighth example and the ninth example which have been described above.

Next, the optical path setting processing unit 104 determines whether or not there is another route (St38). If there is not another route (NO in St38), the optical path setting processing unit 104 terminates the process and, if there is another route (YES in St38), the optical path setting processing unit 104 selects the another route (St32) and executes processing of St33 and subsequent processing.

If there is not a date in which the occurrence band is smaller than the certain value Ma (NO in St36), the optical path setting processing unit 104 increases the default path in accordance with the optical path generation time (St37). Examples of this processing include the tenth example which has been described above. In the tenth example, the certain value Ma is 10 Gbps. Thereafter, processing of St38 is executed.

If the ratio of the occurrence band to the predicted band is smaller than the certain value Ka (NO in St35), the optical path setting processing unit 104 compares the ratio to the certain value Kb (St41). If the ratio is larger than the certain value Kb (NO in St41), the processing of St38 is executed. If the ratio is the certain value Kb or less (Yes in St41), the optical path setting processing unit 104 determines, based on the demand occurrence information DB 133, whether or not there is a date in which the occurrence band is larger than a certain value Mb in the current default path management cycle Ta (St42).

If there is a date in which the occurrence band is larger than the certain value Mb (YES in St42), the optical path setting processing unit 104 reduces the pool path in accordance with the optical path generation time (St44). Examples of this processing include the first example and the second example which have been described above.

Next, the optical path setting processing unit 104 changes the threshold TH in accordance with the optical path generation time (St45). Examples of this processing include the third example and the fourth example which have been described above.

If there is not a date in which the occurrence band is larger than the certain value Mb (NO in St42), the optical path setting processing unit 104 reduces the default path in accordance with the optical path generation time (St43). Examples of this processing include the fifth example which has been described above. In the fifth example, the certain value Mb is 5 Gbps. Thereafter, the processing of St38 is executed.

As described above, the optical path setting processing unit 104 increases or reduces the default path in every period that is longer than a period in which pool path management processing is executed, based on a demand history in the period. Therefore, the network monitoring control device 1 is able to prepare an optical path in accordance with continuity of a demand occurrence state.

As for St39 and St40 which have been described above, only one of St39 and St40 may be executed, but it is enabled by executing both of St39 and St40 to provide an optical path in a more timely manner in accordance with a demand. Similar applies to St44 and St45 described above.

Next, a measurement target route for which an optical path generation time is measured will be described.

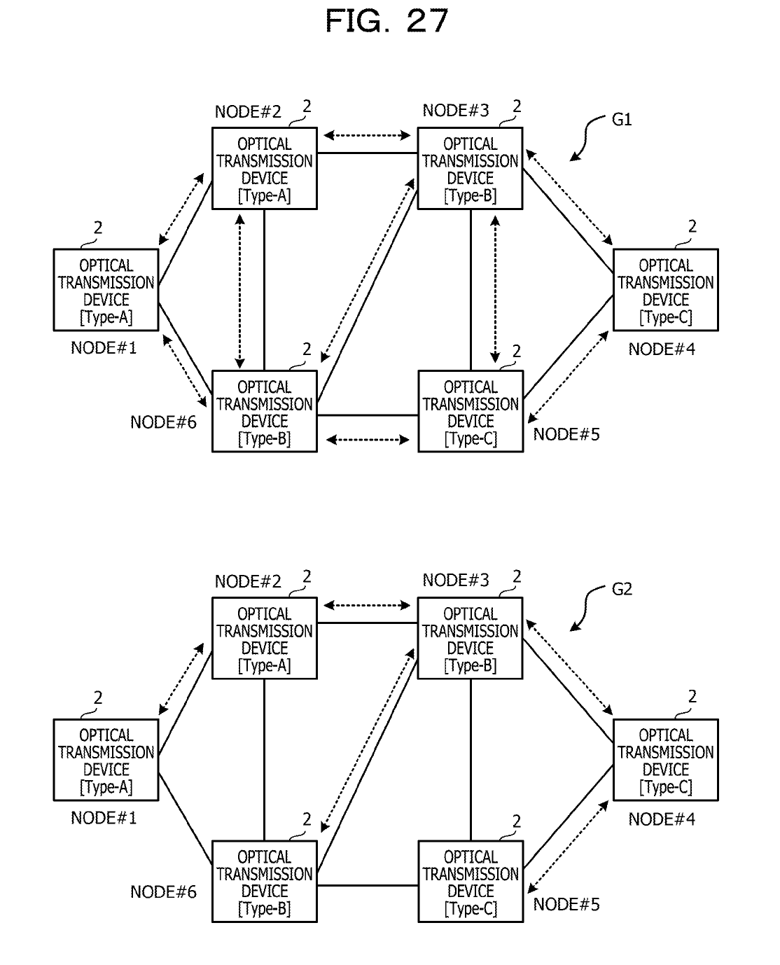

FIG. 27 is a chart illustrating an example of a measurement target route for which an optical path generation time is measured. In FIG. 27, a dotted arrow indicates a measurement target route and a type thereof (Type-A to C) is indicated for each of the nodes #1 and #6. The type of each of the nodes #1 and #2 is “Type-A”. The type of each of the node #3 and #6 is “Type-B”. The type of each of the nodes #4 and #5 is “Type-C”.

In this example, the generation time measurement unit 106 measures the optical path generation time for an optical path having a distance of one hop. As indicated by the reference symbol G1, in a case in which the optical path generation time is measured for all of routes, the number of measurement target routes is nine. In contrast, as indicated by the reference symbol G2, in a case in which the optical path generation time is measured for each combination of the types of nodes on the routes, the number of measurement target routes is only five.

In this case, looking at an optical path between the node #1 and the node #6, the node #1 is “Type-A” and the node #6 is “Type-B”. Therefore, it is considered that the optical path generation time of the optical path between the node #1 and the node #6 is the same as the optical path generation time of an optical path between the node #2 and the node #3 which similarly have a combination of “Type-A” and “Type-B”.

The node #2 and the node #6 also have the combination of “Type-A” and “Type-B”, and therefore, it is considered that the optical path generation time of an optical path between the node #2 and the node #6 is the same as the optical path generation time of the optical path between the node #2 and the node #3. Furthermore, the node #5 and the node #6 have a combination of “Type-C” and “Type-B”, and therefore, it is considered that the optical path generation time of an optical path between the node #5 and the node #6 is the same as the optical path generation time of an optical path between the node #3 and the node #4.

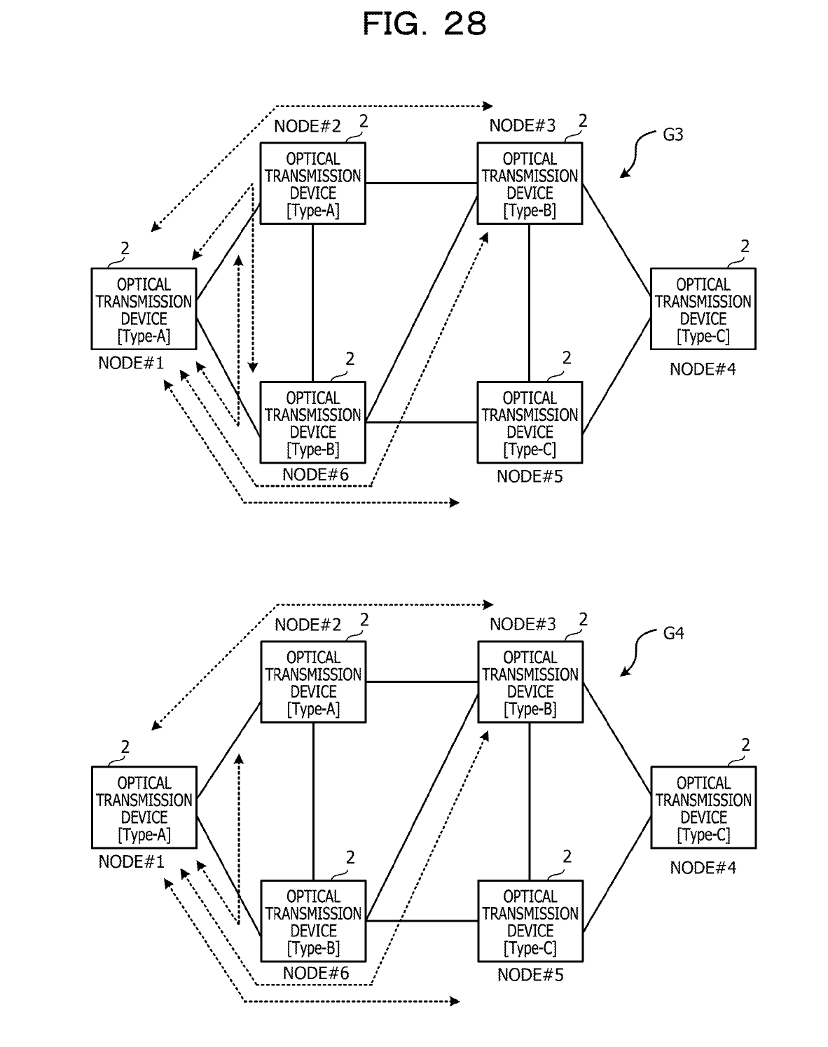

FIG. 28 is a chart illustrating another example of the measurement target route for which an optical path generation time is measured. In FIG. 28, the description of items in common with FIG. 27 will be omitted.

In this example, the generation time measurement unit 106 measures the optical path generation time for an optical path having a distance of two hops. As indicated by the reference symbol G3, in a case in which the optical path generation time is measured for all of routes, the number of measurement target routes is five. In contrast, as indicated by the reference symbol G4, in a case in which the optical path generation time is measured for each combination of the types of nodes on the routes, the number of measurement target routes is only four.

In this case, looking at an optical path that extends via the node #1, the node #2, and the node #6, each of the node #1 and the node #2 is “Type-A” and the node #6 is “Type-B”. Therefore, it is considered that the optical path generation time of the optical path that extends via the node #1, the node #2, and the node #6 is the same as the optical path generation time of an optical path that extends via the node #1, the node #2, and the node #3 which similarly have a combination of two nodes of “Type-A” and one node of “Type-B”.

As described above, the generation time measurement unit 106 executes a measurement of the optical path generation time for each combination of the types of nodes on optical paths, and thereby, an amount of time of measurement processing and a data amount of the optical path generation time DB 136 may be reduced.

In the embodiment that has been described so far, the optical path setting parameter control unit 105 controls a timing at which a pool path is additionally set, based on the optical path generation time and the total of available bands. However, as described below, the optical path setting parameter control unit 105 may be configured to control a timing at which a pool path is additionally set, based on the optical path generation time and the number of unused pool paths. In this case, in the threshold DB 137, instead of the threshold TH of the total of available bands of optical paths, the threshold TH of the number of unused pool paths is registered.

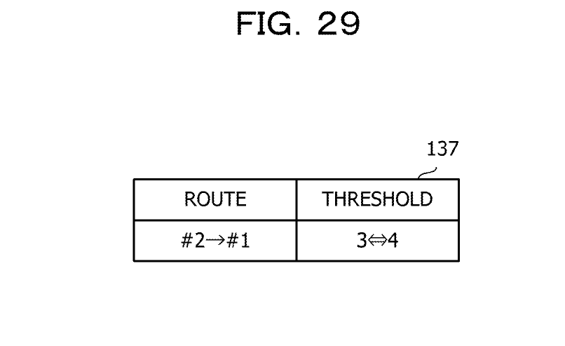

FIG. 29 is a table illustrating another example of the threshold DB 137. In the threshold DB 137, the threshold TH of the number of unused pool paths, that is, the number of optical paths all of bands of which are available, is registered.

The optical path setting parameter control unit 105 adjusts the threshold TH in accordance with the optical path generation time. For example, when the optical path generation time is 30 seconds, the optical path setting parameter control unit 105 performs a control so that the threshold TH is 3 and, when the optical path generation time is 180 seconds, the optical path setting parameter control unit 105 performs a control so that the threshold TH is 4.

Therefore, if the optical path generation time is short, when the number of unused pool paths is 3, a new pool path is set and, if the optical path generation time is long, when the number of unused paths is 4, a new pool path is set. Thus, a timing at which a pool path is additionally set is controlled, based on the optical path generation time and the number of unused pool paths.

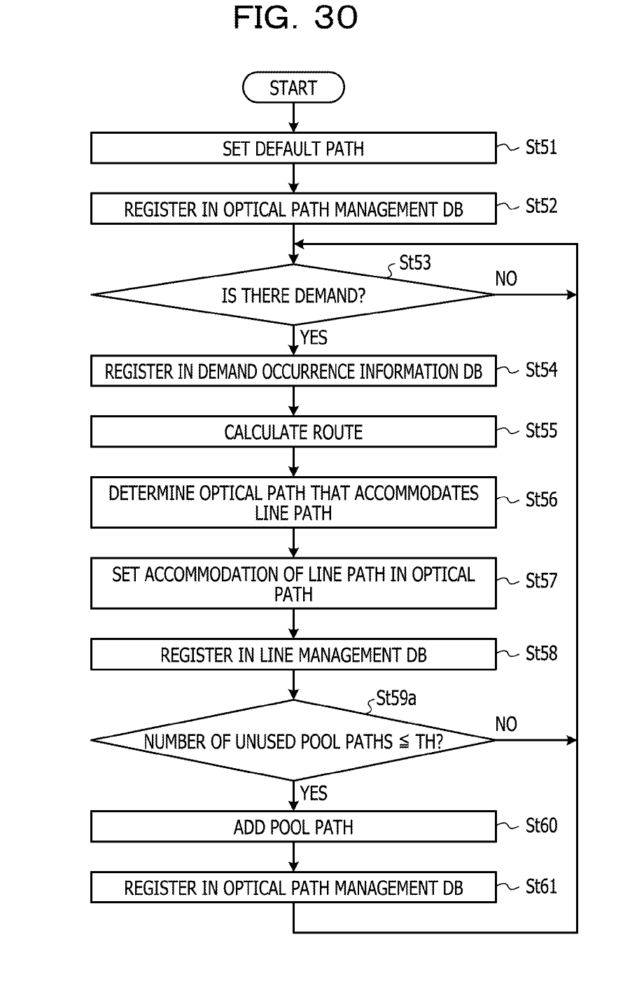

FIG. 30 is a flowchart illustrating another example of demand accommodation processing of this example. In FIG. 30, each processing in common with FIG. 8 is denoted by the same reference symbol as that of the corresponding processing and the description thereof will be omitted.

After processing of St58, the optical path setting processing unit 104 compares the number of pool paths (unused pool paths) which are optical paths that extend via the nodes #1 to #6 that are in common with an optical path of an accommodation destination of a line path and all of bands of which are available to the threshold TH (St59a). In this case, the optical path setting processing unit 104 calculates the number of pool paths, based on the contents of the optical path management DB 135 and the line management DB 134. If the number of pool paths is larger than the threshold TH (NO in St59a), the processing of St53 and subsequent processing are executed.

If the number of pool paths is the threshold TH or less (YES in St59a), the optical path setting processing unit 104 additionally sets a pool path (St60). Next, the optical path setting processing unit 104 registers the pool path which has been added in the optical path management DB 135 (St61). Thereafter, the processing of St53 and subsequent processing are executed. Thus, addition of a pool path is performed in accordance with the number of unused pool paths.

As described with reference to FIG. 24, the optical path setting parameter control unit 105 of this example changes the threshold TH in accordance with the optical path generation time in pool path management processing (St17, St20). Thus, as described above, a timing at which a pool path is additionally set is changed in accordance with the threshold TH.

Furthermore, as described with reference to FIG. 26, the optical path setting parameter control unit 105 of this example changes the threshold TH in accordance with the optical path generation time in default path management processing (St40, St45). Thus, as described above, a timing at which a pool path is additionally set is changed in accordance with the threshold TH.

As described above, when the number of pool paths which are optical paths that extend via the nodes #1 to #6 that are in common with an optical path of an accommodation destination of a line path and all of bands of which are available is the threshold TH or less, the optical path setting processing unit 104 sets a pool path. The optical path setting parameter control unit 105 adjusts the threshold TH in accordance with the optical path generation time.

Therefore, if the threshold TH has increased, a timing at which the number of unused pool paths reduces due to occurrence of a demand to be the threshold TH or less is advanced. On the other hand, if the threshold TH has reduced, a timing at which the number of unused pool paths reduces due to occurrence of a demand to be the threshold TH or less is delayed.

The above-described processing functions may be realized by a computer. In this case, a program in which processing contents of functions that the processing units are to have are described is provided. A computer executes the program, and thereby, the above-described processing functions are realized on the computer. The program in which the processing contents are described may be recorded in a computer-readable recording medium (except for a carrier wave).

In a case in which the program is distributed, for example, the program is sold in a form of a portable recording medium, such as a digital versatile disc (DVD), a compact disc read only memory (CD-ROM), or the like, in which the program is recorded. The program may be stored in a storage device of a server computer in advance and may be transferred from the server computer to another computer via a network.

A computer that executes the program stores, for example, the program that is recorded in a portable recording medium or the program that has been transferred from the server computer in a self-storage device. Then, the computer reads the program from the self-storage device and executes processing in accordance with the program. Also, the computer may be configured to directly read the program from the portable recording medium and execute processing in accordance with the program. The computer may be configured to sequentially execute, each time the program is transferred to the computer from the server computer, processing in accordance with the program that has been received.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network control method which is executed by a processor included in a network control device, the network control method comprising:
measuring an amount of time of generation of an optical path that extends via a plurality of nodes in a network; and
setting the optical path at a timing that is controlled based on the amount of measured time.

2. The network control method according to claim 1, wherein
the setting includes:
assigning a band of the optical path which has been set in the network to a line path in accordance with a request, and
setting the optical path, when, among the optical paths that have been set, the number of the optical paths each of which extends via the plurality of nodes and all of bands of which are available is a threshold or less, and
the timing is controlled by adjusting the threshold in accordance with the amount of time.

3. The network control method according to claim 2, wherein
the timing is controlled in a first period, and
the setting includes increasing or reducing, in every second period that is longer than the first period, the optical path in the network, based on a history of the request in the second period.

4. The network control method according to claim 1, wherein
the setting includes:
assigning a band of the optical path which has been set in the network to a line path in accordance with a request, and
setting the optical path, when, among the optical paths that have been set, the total of available bands of the optical paths each of which extends via the plurality of nodes is a threshold or less, and
the timing is controlled by adjusting the threshold in accordance with the amount of time.

5. The network control method according to claim 1,
wherein the measuring includes measuring the amount of time for each combination of types of the plurality of nodes.

6. The network control method according to claim 1,
wherein the measuring includes measuring the amount of time for each of a plurality of routes in the network.

7. The network control method according to claim 6,
wherein the measuring includes measuring, as the amount of time, a time from a time at which the plurality of nodes is instructed to generate the optical path to a time at which transmission quality of the optical path satisfies a certain condition.

8. The network control method according to claim 1, wherein the measuring includes
determining a route of a measurement target from the network,
selecting an unused wavelength that is in common with each of a plurality of target nodes on the route which has been determined,
measuring the amount of time of generation of the optical path having the wavelength which has been selected,
storing the amount of time which has been measured, and
instructing the plurality of target nodes to delete the optical path which has been generated.

9. The network control method according to claim 1,
wherein the measuring includes measuring the amount of time before use of the network is started.

10. A network control device comprising:
a memory; and
a processor coupled to the memory and configured to:
measure an amount of time of generation of an optical path that extends via a plurality of nodes in a network; and
set the optical path at a timing that is controlled based on the amount of measured time.

11. The network control device according to claim 10, wherein the processor is configured to:
assign a band of the optical path which has been set in the network to a line path in accordance with a request,
set the optical path, when, among the optical paths that have been set, the number of the optical paths each of which extends via the plurality of nodes and all of bands of which are available is a threshold or less, and
control the timing by adjusting the threshold in accordance with the amount of time.

12. The network control device according to claim 10, wherein the processor is configured to:
assign a band of the optical path which has been set in the network to a line path in accordance with a request, and
set the optical path, when, among the optical paths that have been set, the total of available bands of the optical paths each of which extends via the plurality of nodes is a threshold or less, and
control the timing by adjusting the threshold in accordance with the amount of time.

13. The network control device according to claim 10, wherein the processor is configured to measure the amount of time for each of a plurality of routes in the network.

14. The network control device according to claim 13, wherein the processor is configured to measure, as the amount of time, a time from a time at which the plurality of nodes is instructed to generate the optical path to a time at which transmission quality of the optical path satisfies a certain condition.

15. A non-transitory computer-readable recording medium storing a program that causes a processor included in a network control device to execute a process, the process comprising:
measuring an amount of time of generation of an optical path that extends via a plurality of nodes in a network; and
setting the optical path at a timing that is controlled based on the amount of measured time.
